(19) United States
(12) Patent Application Publication
(10) Pub. No.: US 2007/0129926 A1
(43) Pub. Date: Jun. 7, 2007

(54) Hardware acceleration system for simulation of logic and memory

(76) Inventors: Henry T. Verheyen, San Jose, CA (US); William Watt, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/292,712

(22) Filed: Dec. 1, 2005

(51) Int. Cl. G06F 17/50

(52) U.S. Cl. 703/15

(57) ABSTRACT

A hardware-accelerated simulator includes a storage memory and a program memory that are separately accessible by the simulation processor. The program memory stores instructions to be executed in order to simulate the chip. The storage memory is used to simulate the user memory. Since the program memory and storage memory are separately accessible by the simulation processor, the simulation of reads and writes to user memory does not block the transfer of instructions between the program memory and the simulation processor, thus increasing the speed of simulation. In one aspect, user memory addresses are mapped to storage memory addresses by adding a fixed, predetermined offset to the user memory address. Thus, no address translation is required at run-time.

### BACKGROUND OF THE INVENTION

1. Field of the Invention

The present invention relates generally to VLIW (very long instruction word) processors, including for example simulation processors that may be used in hardware acceleration systems for simulation of the design of semiconductor integrated circuits, also known as semiconductor chips. In one aspect, the present invention relates to the use of such systems to simulate both logic and memory in semiconductor chips.

2. Description of the Related Art

Simulation of the design of a semiconductor chip-typically requires high processing speed and a large number of execution steps due to the large amount of logic in the design, the large amount of on-chip and off-chip memory, and the high speed of operation typically present in the designs for modern semiconductor chips. The typical approach for simulation is software-based simulation (i.e., software simulators). In this approach, the logic and memory of a chip (which shall be referred to as user logic and user memory for convenience) are simulated by computer software executing on general purpose hardware. The user logic is simulated by the execution of software instructions that mimic the logic function. The user memory is simulated by allocating main memory in the general purpose hardware and then transferring data back and forth from these memory locations as needed by the simulation. Unfortunately, software simulators typically are very slow. The simulation of a large amount of logic on the chip requires that a large number of operands, results and corresponding software instructions be transferred from main memory to the general purpose processor for execution. The simulation of a large amount of memory on the chip requires a large number of data transfers and corresponding address translations between the address used in the chip description and the corresponding address used in main memory of the general purpose hardware.

Another approach for chip simulation is hardware-based simulation (i.e., hardware emulators). In this approach, user logic and user memory are mapped on a dedicated basis to hardware circuits in the emulator, and the hardware circuits then perform the simulation. User logic is mapped to specific hardware gates in the emulator, and user memory is mapped to specific physical memory in the emulator. Unfortunately, hardware emulators typically require high cost because the number of hardware circuits required in the emulator increases according to the size of the simulated chip design. For example, hardware emulators typically require the same amount of logic as is present on the chip, since the on-chip logic is mapped on a dedicated basis to physical logic in the emulator. If there is a large amount of user logic, then there must be an equally large amount of physical logic in the emulator. Furthermore, user memory must also be mapped onto the emulator, and requires also a dedicated mapping from the user memory to the physical memory in the hardware emulator. Typically, emulator memory is instantiated and partitioned to mimic the user memory. This can be quite inefficient as each memory uses physical address and data ports. Typically, the amount of user logic and user memory that can be mapped depends on emulator architectural features, but both user logic and user memory require physical resources to be included in the emulator and scale upwards with the design size. This drives up the cost of the emulator. It also slows down the performance and complicates the design of the emulator. Emulator memory typically is high-speed but small. A large user memory may have to be split among many emulator memories. This then requires synchronization among the different emulator memories.

Still another approach for logic simulation is hardware-accelerated simulation. Hardware-accelerated simulation typically utilizes a specialized hardware simulation system that includes processor elements configurable to emulate or simulate the logic designs. A compiler is typically provided to convert the logic design (e.g., in the form of a netlist or RTL (Register Transfer Language)) to a program containing instructions which are loaded to the processor elements to simulate the logic design. Hardware-accelerated simulation does not have to scale proportionally to the size of the logic design, because various techniques may be utilized to break up the logic design into smaller portions and then load these portions of the logic design to the simulation processor. As a result, hardware-accelerated simulators typically are significantly less expensive than hardware emulators. In addition, hardware-accelerated simulators typically are faster than software simulators due to the hardware acceleration produced by the simulation processor. One example of hardware-accelerated simulation is described in U.S. Patent Application Publication No. US 2003/0105617 A1, “Hardware Acceleration System for Simulation,” published on Jun. 5, 2003, which is incorporated herein by reference.

However, hardware-accelerated simulators may have difficulty simulating user memory. They typically solve the user memory modeling problem similar to emulators by using physical memory on an instantiated basis to model the user memory, as explained above.

Another approach for hardware-accelerated simulators is to combine hardware-accelerated simulation of user logic and software simulation of user memory. In this approach, user logic is simulated by executing instructions on specialized processor elements, but user memory is simulated by using the main memory of general purpose hardware. However, this approach is slow due to the large number of data transfers and address translations required to simulate user memory. This type of translation often defeats the acceleration, as latency to and from the general purpose hardware decreases the achievable performance. Furthermore, data is often transferred between user logic and user memory. For example, the output of a logic gate may be stored to user memory, or the input to a logic gate may come from user memory. In the hybrid approach, these types of transfers require a transfer between the specialized hardware simulation system and the main memory of general purpose hardware. This can be both complex and slow.

Therefore, there is a need for an approach to simulating both user logic and user memory that overcomes some or all of the above drawbacks.

### SUMMARY OF THE INVENTION

In one aspect, the present invention overcomes the limitations of the prior art by providing a hardware-accelerated simulator that includes a storage memory and a program memory that are separately accessible by the simulation processor. The program memory stores instructions to be executed in order to simulate the chip. The storage memory is used to simulate the user memory. That is, accesses to user memory are simulated by accesses to corresponding parts of the storage memory. Since the program memory and storage memory are separately accessible by the simulation processor, the simulation of reads and writes to user memory does not block the transfer of instructions between the program memory and the simulation processor, thus increasing the speed of simulation.

In one aspect of the invention, the mapping of user memory addresses to storage memory addresses is performed preferably in a manner that requires little or no address translation at run-time. In one approach, each instance of user memory is assigned a fixed offset before run time, typically during compilation of the simulation program. The corresponding storage memory address is determined as the fixed offset concatenated with selected bits from the user memory address. For example, if a user memory address is given by [A B] where A and B are the bits for the word address and bit address, respectively, the corresponding storage memory address might be [C A B] where C is the fixed offset assigned to that particular instance of user memory. The fixed offset is determined before run time and is fixed throughout simulation. During simulation, the user memory address [A B] may be determined as part of the simulation. The corresponding storage memory address can be easily and quickly determined by adding the offset C to the calculated address [A B]. The reduction of address translation overhead increases the speed of simulation.

In another aspect of the invention, the simulation processor includes a local memory and accesses to the storage memory are made via the local memory. That is, data to be written to the storage memory is written from the local memory to the storage memory. Similarly, data read from the storage memory is read from the storage memory to the local memory. In one particular approach, the simulation processor includes n processor elements and data is interleaved among the local memories corresponding to the processor elements. For example, if n bits are to be read from the local memory into the storage memory, instead of reading all n bits from the local memory of processor element 0, 1 bit could be read from the local memory of each of the n processor elements. A similar approach can be used to write data from the storage memory to the local memory. In alternate approaches, data is not interleaved. Instead, data to be read from or written to the local memory is transferred to/from the local memory associated with one specific processor element. In another variation, both approaches are supported, thus allowing data to be converted between the interleaved and non-interleaved format.

In another aspect, the local memory can be used for indirection of instructions. When a write to storage memory or read from storage memory (i.e., a storage memory instruction) is desired, rather than including the entire storage memory instruction in the instruction received by the simulation processor, the instruction received by the simulation processor points to an address in local memory. The entire storage memory instruction is contained at this local memory address. This indirection allows the instructions presented to the simulation processor to be shorter, thus increasing the overall throughput of the simulation processor.

In one specific implementation, the simulation processor is implemented on a board that is pluggable into a host computer and the simulation processor has direct access to a main memory of the host computer, which serves as the program memory. Thus, instructions can be transferred to the simulation processor fairly quickly using the DMA access. The simulation processor accesses the storage memory by a different interface. In one design, this interface is divided into two parts: one that controls reads and writes to the simulation processor and another that controls reads and writes to the storage memory. The two parts communicate with each other via an intermediate interface. This approach results in a modular design. Each part can be designed to include additional functionality specific to the simulation processor or storage memory, respectively.

Other aspects of the invention include devices and systems corresponding to the approaches described above, applications for these devices and systems, and methods corresponding to all of the foregoing. Another aspect of the invention includes VLIW processors with a similar architecture but for purposes other than simulation of semiconductor chips.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram illustrating a hardware-accelerated simulation system according to one embodiment of the present invention.

FIG. 2 is a block diagram illustrating a simulation processor in the hardware-accelerated simulation system according to one embodiment of the present invention.

FIG. 3 is a diagram illustrating one mapping of user memory addresses to storage memory addresses according to the invention.

FIG. 4 is a circuit diagram illustrating a single processor unit of the simulation processor according to a first embodiment of the present invention.

FIG. 5 is a circuit diagram illustrating the trigger for a storage memory transaction, and also writing data from local memory to storage memory.

FIG. 6 is a bit map illustrating the format of an instruction for a storage memory transaction.

FIG. 7 is a circuit diagram illustrating reading data from storage memory into local memory.

FIG. 8 is a block diagram illustrating one embodiment of an interface between the simulation processor and the storage memory.

FIG. 9 is a circuit diagram of an alternate memory architecture.

FIGS. 10-14 are circuit diagrams illustrating various read and write operations for the architecture shown in FIG. 9.

FIGS. 15A and 15B are circuit diagrams of further memory architectures.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

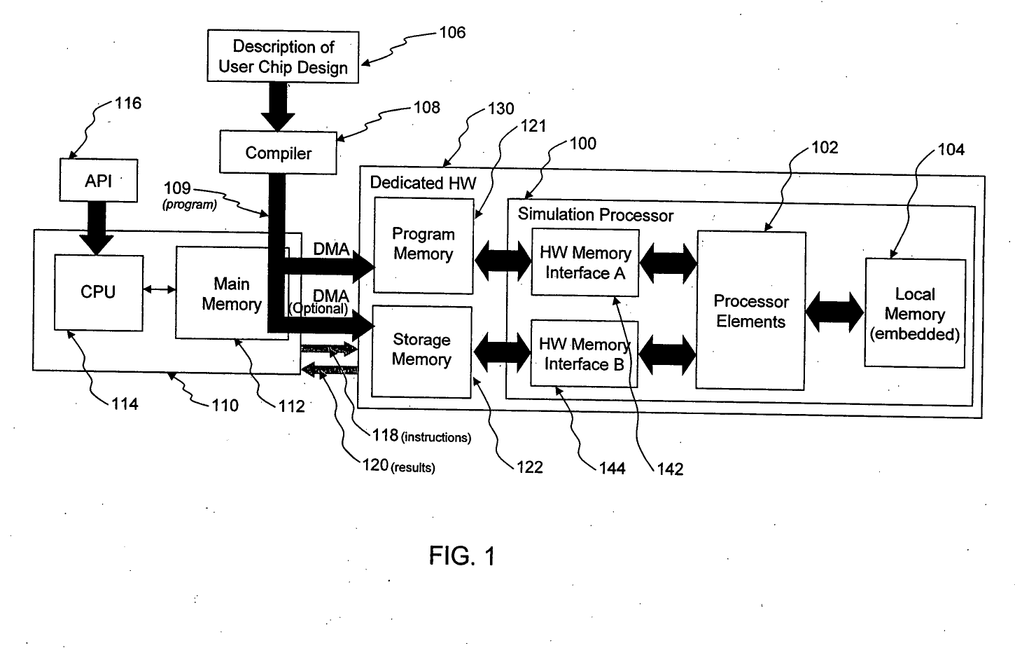

FIG. 1 is a block diagram illustrating a hardware accelerated logic simulation system according to one embodiment of the present invention. The logic simulation system includes a dedicated hardware (HW) simulator 130, a compiler 108, and an API (Application Programming Interface) 116. The host computer 110 includes a CPU 114 and a main memory 112. The API 116 is a software interface by which the host computer 110 controls the hardware simulator 130. The dedicated HW simulator 130 includes a program memory 121, a storage memory 122, and a simulation processor 100 that includes the following: processor elements 102, an embedded local memory 104, a hardware (HW) memory interface A 142, and a hardware (HW) memory interface B 144.

The system shown in FIG. 1 operates as follows. The compiler 108 receives a description 106 of a user chip or design, for example, an RTL (Register Transfer Language) description or a netlist description of the design. The description 106 typically includes descriptions of both logic functions within the chip (i.e., user logic) arid on-chip memory (i.e., user memory). The description 106 typically represents the user logic design as a directed graph, where nodes of the graph correspond to hardware blocks in the design, and typically represents the user memory by a behavioral or functional (i.e., non-synthesizable) description (although synthesizable descriptions can also be handled). The compiler 108 compiles the description 106 of the design into a program 109. The program contains instructions that simulate the user logic and that simulate the user memory. The instructions typically map the user logic within design 106 against the processor elements 102 in the simulation processor 100 in order to simulate the function of the user logic. The description 106 received by the compiler 108 typically represents more that just the chip or design itself. It often also represents the test environment used to stimulate the design for simulation purposes (i.e., the testbench). The system can be designed to simulate both the chip design and the testbench (including cases where the testbench requires blocks of user memory).

The instructions typically map user memory within design 106 against locations within the storage memory 122. Data from the storage memory 122 is transferred back and forth to the local memory 104, as needed by the processor elements 102. For purposes of simulation, functions that access user memory are simulated by instructions that access corresponding locations in the storage memory. For example, a function of write-to-user-memory at a certain user memory address is simulated by instructions that write to storage memory at the corresponding storage memory address. Similarly, a function of read-from-user-memory at a certain user memory address is simulated by instructions that read from storage memory at the corresponding storage memory address.

For further descriptions of example compilers 108, see U.S. Patent Application Publication No. US 2003/0105617 A1, “Hardware Acceleration System for Simulation,” published on Jun. 5, 2003, which is incorporated herein by reference. See especially paragraphs 191-252 and the corresponding figures. The instructions in program 109 are stored in memory 112.

The simulation processor 100 includes a plurality of processor elements 102 for simulating the logic gates of the user logic and a local memory 104 for storing instructions and data for the processor elements 102. In one embodiment, the HW simulator 130 is implemented on a generic PCI-board using an FPGA (Field-Programmable Gate Array) with PCI (Peripheral Component Interconnect) and DMA (Direct Memory Access) controllers, so that the HW simulator 130 naturally plugs into any general computing system, host computer 110. The simulation processor 100 forms a portion of the HW simulator 130. The simulation processor 100 has direct access to the main memory 112 of the host computer 110, with its operation being controlled by the host computer 110 via the API 116. The host computer 110 can direct DMA transfers between the main memory 112 and the memories 121, 122 on the HW simulator 130, although the DMA between the main memory 112 and the memory 122 may be optional.

The host computer 110 takes simulation vectors (not shown) specified by the user and the program 109 generated by the compiler 108 as inputs, and generates board-level instructions 118 for the simulation processor 100. The simulation vectors (not shown) includes values of the inputs to the netlist 106 that is simulated. The board-level instructions 118 are transferred by DMA from the main memory 112 to the program memory 121 of the HW simulator 130. The memory 121 also stores results 120 of the simulation for transfer to the main memory 112. The storage memory 122 stores user memory data, and can alternatively (optionally) store the simulation vectors (not shown) or the results 120. The memory interfaces 142, 144 provide interfaces for the processor elements 102 to access the memories 121, 122, respectively. The processor elements 102 execute the instructions 118 and, at some point, return simulation results 120 to the host computer 110 also by DMA. Intermediate results may remain on-board for use by subsequent instructions. Executing all instructions 118 simulates the entire netlist 106 for one simulation vector. A more detailed discussion of the operation of a hardware-accelerated simulation system such as that shown in FIG. 1 can be found in United States Patent Application Publication No. US 2003/0105617 A1 published on Jun. 5, 2003, which is incorporated herein by reference in its entirety.

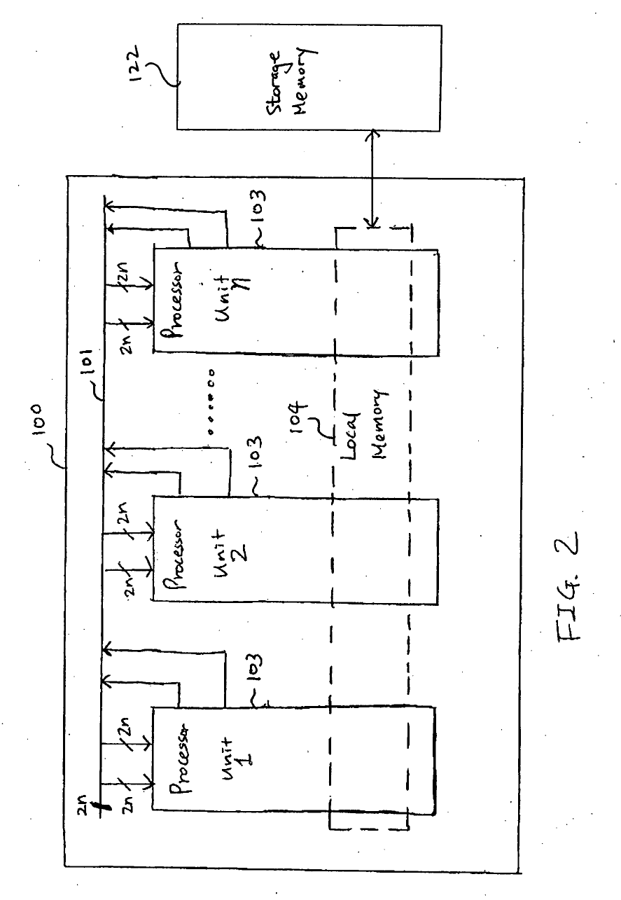

FIG. 2 is a block diagram illustrating the simulation processor 100 in the hardware-accelerated simulation system according to one embodiment of the present invention. The simulation processor 100 includes n processor units 103 (Processor Unit 1, Processor Unit 2, . . . Processor Unit n) that communicate with each other through an interconnect system 101. In this example, the interconnect system is a non-blocking crossbar. Each processor unit can take up to two inputs from the crossbar, so for n processor units, 2n input signals are available, allowing the input signals to select from 2n signals (denoted by the inbound arrows with slash and notation “2n”). Each processor unit can generate up to two outputs for the crossbar (denoted by the outbound arrows). For n processor units, this produces the 2n output signals. Thus, the crossbar is a 2n (output from the processor units)×2n (inputs to the processor units) crossbar that allows each input of each processor unit 103 to be coupled to any output of any processor unit 103. In this way, an intermediate value calculated by one processor unit can be made available for use as an input for calculation by any other processor unit.

For a simulation processor 100 containing n processor units, each having 2 inputs, 2n signals must be selectable in the crossbar for a non-blocking architecture. If each processor unit is identical, each preferably will supply two variables into the crossbar. This yields a 2n×2n non-blocking crossbar. However, this architecture is not required. Blocking architectures, non-homogenous architectures, optimized architectures (for specific design styles), shared architectures (in which processor units either share the address bits, or share either the input or the output lines into the crossbar) are some examples where an interconnect system 101 other than a non-blocking 2n×2n crossbar may be preferred.

Each of the processor units 103 includes a processor element (PE), a local cache, and a corresponding part of the local memory 104 as its memory. Therefore, each processor unit 103 can be configured to simulate at least one logic gate of the user logic and store intermediate or final simulation values during the simulation.

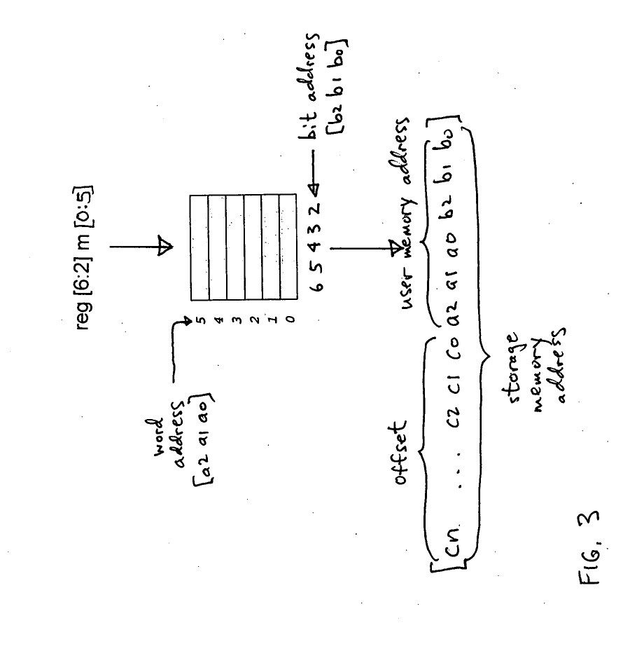

FIG. 3 illustrates one mapping of user memory addresses to storage memory addresses according to the invention. Semiconductor chips can have a large number of memory instances, each of which may have a different size. They can vary from fairly small (e.g. internal FIFOs) to very large (e.g. internal DRAM or external memory). Memory instances are typically described as containing a certain number of words, each of which has a certain number of bits. For example, an instance of user memory may be described by the nomenclature: reg [length] m [#words], where “length” defines the length of each word and “#words” defines the number of words in the memory instance.

Typically, the length field is a bit-packed field, representing the length of each word in the number of bits: e.g. [3:0] defines length to be 4 bits, and [9:3] defines length to be 7 bits (using bits 3 thru 9). The #words field is unpacked, it merely list the valid range for-the memory. For example, [0:31] defines #words to be 32 (words), and [1024:1028] defines #words to be 5 (words), starting at value 1024.

For example, reg [6:2] m [0:5] is an instance of user memory that has 6 words total (as defined by the range 0:5), each of which is 5 bits long (as defined by the range 6:2), as shown in FIG. 3. In the figure, each row represents one word and the numbers 0 to 5 (or 000 to 101 in binary) represent the word address. There are five bits in each word, as represented by the numbers 2 to 6 (or 010 to 110). For convenience, the word address may be represented by the bits a0, a1, a2, etc. where a0 is the least significant bit. Similarly, the bit address may be represented by bits b0, b1, b2, etc. In the example of FIG. 3, the word address would contain three bits a2 a1 a0 and the bit address would also contain three bits b2 b1 b0. If the memory instance is addressed on a word basis, only the word address needs to be specified as the bit address would be zero (i.e. b2=0, b1=0, and b0=0). If specific bits are being addressed, then both the word address and the bit address are used. In this example, if an individual bit is addressed, the relative user memory address would be [a2 a1 a0 b2 b1 b0]. The total address length is the sum of the word address length (3 bits in this example) and the bit address length (also 3 bits in this example).

Note that this description applies to 2-state logic simulation, in which a bit in the circuit (e.g., an input bit or output bit of a gate) can only take one of two possible states during the simulation (e.g., either 0 or 1). Therefore, the state of the bit can be represented by a single bit during the simulation. In contrast, in 4-state logic simulation, a bit in the circuit can take one of four possible states (e.g., 0, 1, X or Z) and is represented by two bits during the simulation. The addressing for 4-state simulation can be achieved by adding an additional bit to the 2-state address. For example, if [a2, a1, a0, b2, b1, b0] is the 2-state address of a particular bit (or, more accurately, the state of a particular bit), then [a2, a1, a0, b2, b1, b0, 4st] can be used as the 4-state address of the bit. Here, “4st” is the additional bit added for 4-state simulation, where 4st=1 is the msb of the 2-bit state and 4st=0 is the 1sb. Assume that the 4-state encoding is logic0=00, logic1=01, logicX=10 and logicZ=11. If the state of the bit [a2, a1, a0, b2, b1, b0] is X, the bit at [a2, a1, a0, b2, b1, b0, 1] would be 1 (the msb of the X encoding) and the bit at [a2, a1, a0, b2, b1, b0, 0] would be 0 (the 1sb of the X encoding). Similar approaches can be used to extend to other multi-state simulations. For clarity, the bulk of this description is made with respect to 2-state simulation but the principles are equally applicable to 4-state and other numbers of states.

A single semiconductor chip typically has a large number of memory instances, each of which is defined and addressed as described in FIG. 3. These user memories are mapped to the storage memory 122 for simulation purposes. One instance of user memory is mapped to one area of storage memory 122, another instance of user memory is mapped to a different area of storage memory 122, and so on.

FIG. 3 illustrates one implementation of this mapping. The storage memory 122 typically will be much larger than any single instance of user memory. Therefore, the storage memory address will be longer than the user memory address. For example, if the storage memory is 1 GB, then the storage memory address will contain 33 bits if bit-wise addressing is desired. In contrast, the user memory shown in FIG. 3 has an address with only 6 bits. The 6-bit user memory address is converted to a 33-bit storage memory address by adding a 27-bit offset to the user memory address. This offset is denoted by bits c0, c1, c2, etc. A 10-bit memory address would be converted to a 33-bit storage memory address by adding a 23-bit offset. The offsets are selected so that different instances of user memory are mapped to different areas of storage memory. That is, two different instances of user memory should not be stored at the same location in storage memory.

In addition, the offsets preferably are selected to achieve more efficient packing of the storage memory. As a simple example to illustrate the point, assume that a semiconductor chip has five instances of user memory with varying address lengths, as shown below:

TABLE 1
Listing of User Memory Instances

| User Memory | Length of User | |
|---|---|---|
| Instance | Memory Address | User Memory Address |
| M1 | 4 bits | a1 a0 b1 b0 |
| M2 | 10 bits | a3 a2 a1 a0 b5 b4 b3 b2 b2 b0 |
| M3 | 4 bits | a2 a1 a0 b0 |
| M4 | 4 bits | a1 a0 b1 b0 |
| M5 | 6 bits | a1 a0 b3 b2 b1 b0 |

Also assume that the storage memory address has 13 bits. The user memory instances shown above could be mapped to the storage memory as follows:

TABLE 2
Loose Packing of User Memory Instances

| User Memory | Length of User | |
|---|---|---|
| Instance | Memory Address | Storage Memory Address |
| M1 | 4 bits | 0 0 0 0 0 0 0 0 0 a1 a0 b1 b0 |
| M2 | 10 bits | 0 0 1 a3 a2 a1 a0 b5 b4 b3 b2 b2 b0 |
| M3 | 4 bits | 0 1 0 0 0 0 0 0 0 a2 a1 a0 b0 |
| M4 | 4 bits | 0 1 0 0 0 0 0 0 1 a1 a0 b1 b0 |
| M5 | 6 bits | 0 1 0 0 0 0 1 a1 a0 b3 b2 b1 b0 |

However, a more efficient mapping is the following:

TABLE 3
Dense Packing of User Memory Instances

| User Memory | Length of User | |
|---|---|---|
| Instance | Memory Address | Storage Memory Address |
| M1 | 4 bits | 0 0 0 0 0 0 0 0 0 a1 a0 b1 b0 |
| M3 | 4 bits | 0 0 0 0 0 0 0 0 1 a2 a1 a0 b0 |
| M4 | 4 bits | 0 0 0 0 0 0 0 1 0 a1 a0 b1 b0 |
| M5 | 6 bits | 0 0 0 0 0 0 1 a1 a0 b3 b2 b1 b0 |
| M2 | 10 bits | 0 0 1 a3 a2 a1 a0 b5 b4 b3 b2 b2 b0 |

This mapping results in closer packing and less wasted space in the storage memory. Other packing approaches can also be used.

One advantage of the approach shown above is that no translation is required during simulation, to convert user memory addresses to storage memory addresses. During simulation, an operand to a function may be located at a user memory address that is calculated earlier in the simulation. With the approach shown above, the offsets are assigned in advance by the compiler and are constant throughout the simulation. Therefore, once the user memory address for the operand has been determined in the simulation, the corresponding storage memory address can be quickly determined by concatenating the pre-determined offset with the calculated user memory address. In contrast, if conversion between user memory addresses and storage memory addresses required a translation, there would be a delay while this translation took place.

Another advantage of this approach is that many user memories, including user memories of varying sizes, can be mapped to a common storage memory. As a result, an increase in user memory can be accommodated simply by adding more storage memory.

The approach shown above is not the only possible mapping. For example, instead of using the user memory address directly, the corresponding storage memory address could be based on a simple logic function applied to the user memory address. For example, the storage memory address could be based on adding a pre-determined “offset value” to the corresponding user memory address. The offset value for each instance of user memory would be determined by the compiler and the addition preferably would be implemented in hardware to reduce delays. The offset value can be retrieved from the memory header information if expanded. Alternatively, it can be retrieved by using a lookup table. Each instance of user memory is assigned a memory ID, and the lookup table maps memory IDs to the corresponding offset values. The lookup table can be pre-filled since the memory IDs and offset values are calculated by the compiler before run-time.

The logic function preferably is “simple,” meaning that it can be quickly evaluated at run-time, preferably within a single clock cycle or at most a few clock cycles. Furthermore, the evaluation of the logic function preferably does not add delay to the clock period. One advantage of this approach compared to fully software simulators is that software simulators typically require a large number of operations to simulate user memory. In software simulators, portions of main memory 112 are allocated to simulate the user memory. Calculating the correct memory address and then accessing that address in main memory 112 typically has a significant latency. Compared to hardware emulators, the approach described above is simpler and more scalable. In hardware emulators, user memory is partitioned among different hardware “blocks,” each of which may have its own physical location and access method. The partitioning itself may be complex, possibly requiring manual assistance from the user. In addition, accesses to user memory during simulation may be more complex since the correct hardware block must first be identified, and then the access method for that particular hardware block must be used.

The example given above was based on a simple user memory declaration in order to illustrate the underlying principle. More complex variations will be apparent. For example, in various languages, such as System Verilog and SystemC, extensions of the reg [ ] m [ ] declaration are supported reg [4:0][12:9][5:0] m [0:5][10:12] is an example of a multi-dimensional declaration (packed and unpacked in System Verilog). This declaration defines a user memory of 18 words (6 for [0:5], times 3 for [10:12]), with each word having a length of 120 bits (5 for [4:0], times 4 for [12:9], times 6 for [5:0]). The total user memory contains 18×120=2160 bits. This could be addressed by 12 bits, since 2ˆ12=4096, but this typically would require a more complex translation between the defined user memory address and the corresponding 12 bits.

Instead, as described above with respect to the simpler memory declaration, an offset can be added to the user memory address to obtain the storage memory address. Thus, the corresponding storage memory address could be defined as [C a22 a21 a20 a11 a10 b22 b21 b20 b11 b10 b02 b01 b00], where C is a constant offset, the axx bits correspond to the word address and the bxx bits correspond to the bit address. In this example, [a22 a21 a20] are three bits corresponding to m [0:5][ ] and [a11 a10] are two bits corresponding to m [ ][10:12]. Bits [b22 b21 b20] correspond to reg [4:0][ ][ ], [b11 b10] correspond to reg [ ][12:9][ ], and [b02 b01 b00] correspond to reg [ ][ ][5:0]. This mapping requires 13 bits, rather than the minimum of 12.

In the above example, the addresses [0:5] are 000 to 101 in binary and can be used directly as the three bits [a22 a21 a20] without any manipulation. However, the addresses [10:12] are 1010 to 1100 in binary, which is four bits rather than two, so they cannot be used directly as the two bits [a11 a10]. Rather, they are mapped to the two bits [a11 a10], which can be achieved in a number of different ways. In one approach, [a11 a10] is calculated as the address minus 10. Thus, the address 10 maps to [00], address 11 maps to [0 1] and address 12 maps to [1 0].

In an alternate approach, [a11 a10] is based on the least significant bits of the addresses [10:12]. For example the address range [1024:1027] includes the addresses [10000000000, 10000000001, 10000000010, 10000000011]. The first nine bits are the same for all addresses in the range. Therefore, rather than using all 11 bits, only the last 2 bits could be used and the first 9 bits are discarded. The address 1024 maps to [0 0] in the storage memory address, 1025 maps to [0 1], 1026 maps to [1 0] and 1027 maps to [1 1].

Now consider the address range [1023:1026], which are the addresses [01111111111, 10000000000, 10000000001, 10000000010]. In this example, all 11 bits vary. However, the last two bits still uniquely identify each address in the range. Address 1023 maps to [1 1], 1024 maps to [0 0], 1025 maps to [0 1], and 1026 maps to [1 0]. Thus, the storage memory address can be based on a fixed offset concatenated with these two bits. In general, if an address range has N addresses, then the ceil(log2(N)) least significant bits will uniquely identify each address in the range.

If it is desired to use the user memory addresses directly in the storage memory address with absolutely no manipulation, then more bits may be required. In this example, m [0:5][] uses 3 bits and m [ ][10:12] uses 4 bits (instead of two in the above example). Similar to reg [4:0][ ][ ], reg [ ][12:9][ ], and reg [ ][ ][5:0] use 3, 4 and 3 bits, respectively, This yields a total of 3+4+3+4+3=17 bits rather than the 12 minimum. The mapping is more sparse. However, the intervening unused storage memory addresses typically can be used by other user memory addresses. For example, reg [4:0][12:9][5:0] m [0:5][10:12] and reg [4:0][7:2][5:0] m [0:5][10:12] can be mapped to the same offset C without colliding in the storage memory.

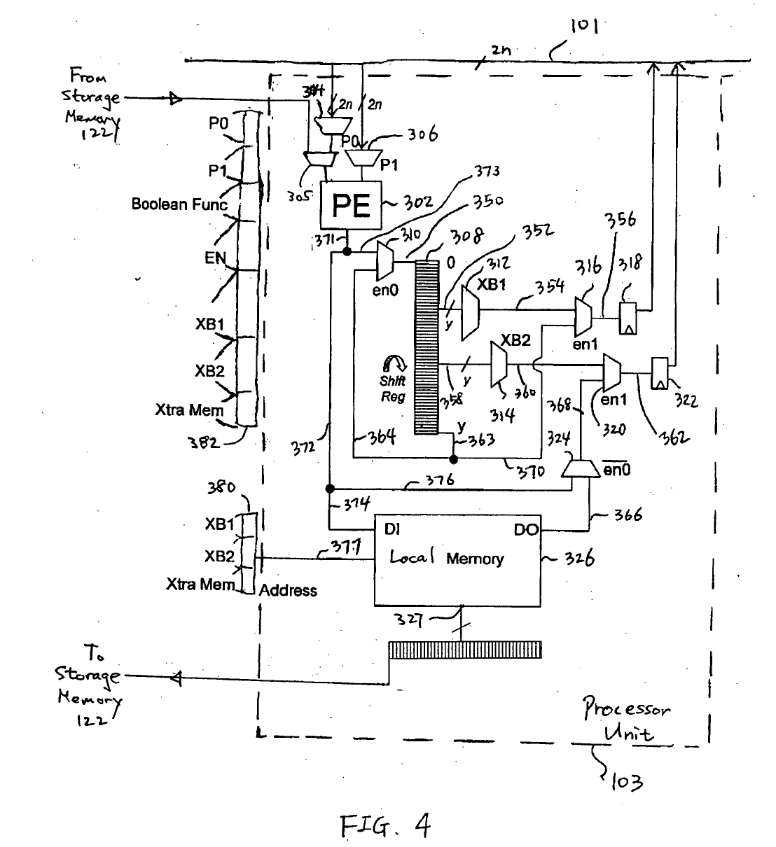

FIGS. 4-8 illustrate one example of the interaction of the storage memory 122, local memory 104 and processor elements 102. FIG. 4 is a circuit diagram illustrating a single processor unit 103 of the simulation processor 100 in the hardware accelerated logic simulation system according to a first embodiment of the present invention. Each processor unit 103 includes a processor element (PE) 302, a local cache 308 (implemented as a shift register in this example), an optional dedicated memory 326, multiplexers 304, 305, 306, 310, 312, 314, 316, 320, 324, and flip flops 318, 322. The processor unit 103 is controlled by instructions 118, the relevant portion of which is shown as 382 in FIG. 4. The instruction 382 has fields P0, P1, Boolean Func, EN, XB1, XB2, and Xtra Mem in this example. Let each field X have a length of Xbits. The instruction length is then the sum of P0, P1, Boolean Func, EN, XB1, XB2, and Xtra Mem in this example. A crossbar 101 interconnects the processor units 103. The crossbar 101 has 2n bus lines, if the number of PEs 302 or processor units 103 in the simulation processor 100 is n and each processor unit has two inputs and two outputs to the crossbar.

In a 2-state implementation, n represents n signals that are binary (either 0 or 1). In a 4-state implementation, n represents n signals that are 4-state coded (0, 1, X or Z) or dual-bit coded (e.g., 00, 01, 10, 11). In this case, we also refer to the n as n signals, even though there are actually 2n electrical (binary) signals that are being connected. Similarly, in a three-bit encoding (8-state), there would be 3n electrical signals, and so forth.

The PE 302 is a configurable ALU (Arithmetic Logic Unit) that can be configured to simulate any logic gate with two or fewer inputs (e.g., NOT, AND, NAND, OR, NOR, XOR, constant 1, constant 0, etc.). The type of logic gate that the PE 302 simulates depends upon Boolean Func, which programs the PE 302 to simulate a particular type of logic gate. This can be extended to Boolean operations of three or more inputs by using a PE with more than two inputs.

The multiplexer 304 selects input data from one of the 2n bus lines of the crossbar 101 in response to a selection signal P0 that has P0 bits, and the multiplexer 306 selects input data from one of the 2n bus lines of the crossbar 101 in response to a selection signal P1 that has P1 bits. When data is not being read from the storage memory 122, the PE 302 receives the input data selected by the multiplexers 304, 306 as operands (i.e., multiplexer 305 selects the output of multiplexer 304), and performs the simulation according to the configured logic function as indicated by the Boolean Func signal. In the example of FIG. 4, each of the multiplexers 304, 306 for every processor unit 103 can select any of the 2n bus lines. The crossbar 101 is fully non-blocking and exhaustively connective, although this is not required.

When data is being read from the storage memory 122, the multiplexer 305 selects the input line coming (either directly or indirectly) from the storage memory 122 rather than the output of multiplexer 304. In this way, data from the storage memory 122 can be provided to the processor units, as will be described in greater detail below.

The shift register 308 has a depth of y (has y memory cells), and stores intermediate values generated while the PEs 302 in the simulation processor 100 simulate a large number of gates of the logic design 106 in multiple cycles.

In the embodiment shown in FIG. 4, a multiplexer 310 selects either the output 371-373 of the PE 302 or the last entry 363-364 of the shift register 308 in response to bit en0 of the signal EN, and the first entry of the shift register 308 receives the output 350 of the multiplexer 308. Selection of output 371 allows the output of the PE 302 to be transferred to the shift register 308. Selection of last entry 363 allows the last entry 363 of the shift register 308 to be recirculated to the top of the shift register 308, rather than dropping off the end of the shift register 308 and being lost. In this way, the shift register 308 is refreshed. The multiplexer 310 is optional and the shift register 308 can receive input data directly from the PE 302 in other embodiments.

On the output side of the shift register 308, the multiplexer 312 selects one of the y memory cells of the shift register 308 in response to a selection signal XB1 that has AB1 bits as one output 352 of the shift register 308. Similarly, the multiplexer 314 selects one of they memory cells of the shift register 308 in response to a selection signal XB2 that has XB2 bits as another output 358 of the shift register 308. Depending on the state of multiplexers 316 and 320, the selected outputs can be routed to the crossbar 101 for consumption by the data inputs of processor units 103.

The dedicated local memory 326 is optional. It allows handling of a much larger design than just the shift-register 308 can handle. Local memory 326 has an input port DI and an output port DO for storing data to permit the shift register 308 to be spilled over due to its limited size. In other words, the data in the shift register 308 may be loaded from and/or stored into the memory 326. The number of intermediate signal values that may be stored is limited by the total size of the memory 326. Since memories 326 are relative inexpensive and fast, this scheme provides a scalable, fast and inexpensive solution for logic simulation. The memory 326 is addressed by an address signal 377 made up of XB1, XB2 and Xtra Mem. Note that signals XB1 and XB2 were also used as selection signals for multiplexers 312 and 314, respectively. Thus, these bits have different meanings depending on the remainder of the instruction. These bits are shown twice in FIG. 4, once as part of the overall instruction 382 and once 380 to indicate that they are used to address local memory 326.

The input port DI is coupled to receive the output 371-372-374 of the PE 302. Note that an intermediate value calculated by the PE 302 that is transferred to the shift register 308 will drop off the end of the shift register 308 after y shifts (assuming that it is not recirculated). Thus, a viable alternative for intermediate values that will be used eventually but not before y shifts have occurred, is to transfer the value from PE 302 directly to dedicated local memory 326, bypassing the shift register 308 entirely (although the value could be simultaneously made available to the crossbar 101 via path 371-372-376-368-362). In a separate data path, values that are transferred to shift register 308 can be subsequently moved to memory 326 by outputting them from the shift register 308 to crossbar 101 (via data path 352-354-356 or 358-360-362) and then re-entering them through a PE 302 to the memory 326. Values that are dropping off the end of shift register 308 can be moved to memory 326 by a similar path 363-370-356.

The output port DO is coupled to the multiplexer 324. The multiplexer 324 selects either the output 371-372-376 of the PE 302 or the output 366 of the memory 326 as its output 368 in response to the complement (˜en0) of bit en0 of the signal EN. In this example, signal EN contains two bits: en0 and en1. The multiplexer 320 selects either the output 368 of the multiplexer 324 or the output 360 of the multiplexer 314 in response to another bit en1 of the signal EN. The multiplexer 316 selects either the output 354 of the multiplexer 312 or the final entry 363, 370 of the shift register 308 in response to another bit en1 of the signal EN. The flip-flops 318, 322 buffer the outputs 356, 362 of the multiplexers 316, 320, respectively, for output to the crossbar 101.

The dedicated local memory 326 also has a second output port 327, which leads eventually to the storage memory 122. In this particular example, output port 327 can be used to read data out of the local memory a word at a time.

Referring to the instruction 382 shown in FIG. 4, the fields can be generally divided as follows. P0 and P1 determine the inputs from the crossbar to the PE 302. EN is primarily a two-bit opcode. Boolean Func determines the logic gate to be implemented by the PE 302. XB1, XB2 and Xtra Mem either determine the outputs of the processor unit to the crossbar 101, or determine the memory address 377 for local memory 326.

In one embodiment, four different operation modes (Evaluation, No-Operation, Store, and Load) can be triggered in the processor unit 103 according to the bits en1 and en0 of the signal EN, as shown below in Table 4:

TABLE 4
Op Codes for field EN

| Mode | en1 | en0 |
|---|---|---|
| Evaluation | 0 | 0 |
| No-Op | 0 | 1 |
| Load | 1 | 0 |
| Store | 1 | 1 |

Generally speaking, the primary function of the evaluation mode is for the PE 302 to simulate a logic gate (i.e., to receive two inputs and perform a specific logic function on the two inputs to generate an output). In the no-operation mode, the PE 302 performs no operation. The mode may be useful, for example, if other processor units are evaluation functions based on data from this shift register 308, but this PE is idling. In the load and store modes, data is being loaded from or stored to the local memory 326. The PE 302 may also be performing evaluations. U.S. patent application Ser. No. 11/238,505, “Hardware Acceleration System for Logic Simulation Using Shift Register as Local Cache,” filed Sep. 28, 2005 by Watt and Verheyen, provides further descriptions of these modes, which are incorporated herein by reference.

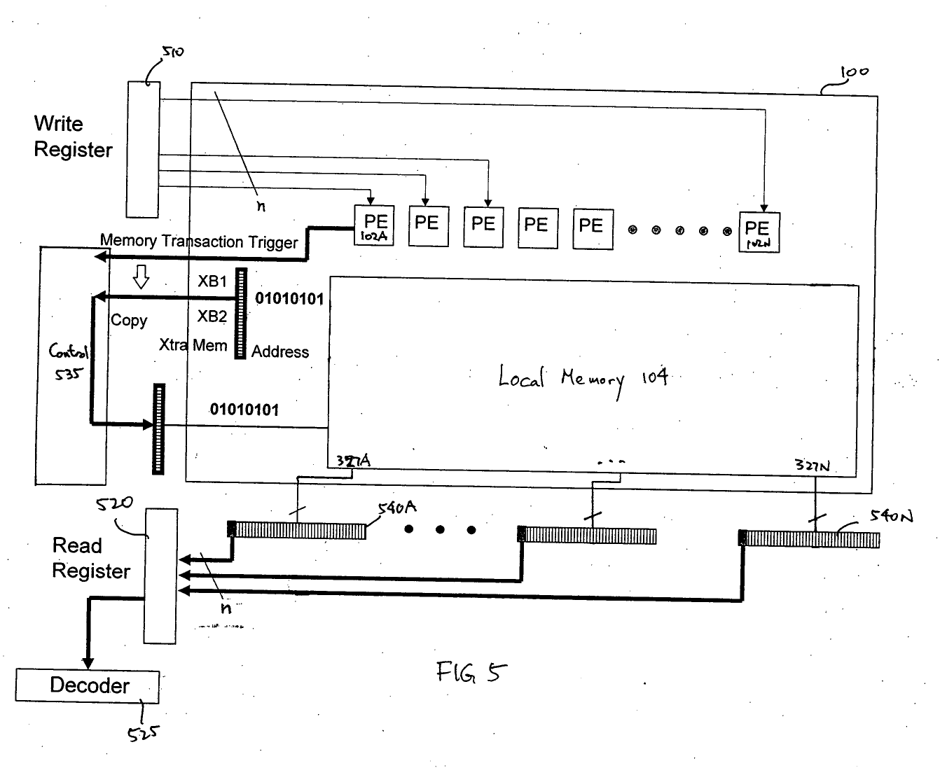

In this example, reads and writes to the storage memory 122 (not to be confused with loads and stores to the local memory 326) are triggered by a special P0/P1 field overload on PE0. In one implementation, if PE0 receives an instruction with EN=01 (i.e., no-op mode) and P0=P1=0000, then a memory transaction is triggered, as shown in FIG. 5. Other instructions can also be used to trigger a memory transaction. FIG. 5 shows the simulation processor 100, which includes processor elements 102, depicted as n processor elements 102A-102N, and a local memory 104. In FIG. 5, the local memory 104 is shown as a single structure rather than n separate memories dedicated to specific processor elements (as in FIG. 4). This is done purely for purposes of illustration. The single local memory 104 shown in FIG. 5 is the concatenation of the n local memories 326 shown in FIG. 4. FIG. 5 also shows a write register 510 and a read register 520 and decoder 525. The write register 510 provides an interface for writing to the simulation processor elements 102, data that is read from the storage memory 122. The read register 520 provides an interface for reading from the simulation processor elements 102, data that is to be written to the storage memory 122. The decoder 525 and control circuitry 535 help to control storage memory transactions.

Upon receipt of the memory transaction trigger instruction, the fields XB1, XB2 and Xtra Mem in the PE0 instruction are interpreted as an address into the local memory 104. In this particular example, the address includes a word address and a bit address. For example, a certain number of the bits in fields XB1, XB2 and Xtra Mem may represent the word address, with the remaining bits representing the bit address. In FIG. 5, the address is represented by the bit string 01010101 (merely as an example). The control circuitry 535 applies the word address portion of this memory address to the output ports 327 of the local memory 104 corresponding to all n processor elements and reads out the n words stored at this local memory address. In FIG. 5, these words are represented by symbols 540A-540N. Word 540A is the word located at the word address portion of address 10101010 for dedicated local memory 326A (corresponding to PE 102A); word 540B is the word located at the same word address for local memory 326B (corresponding to PE 102B), and so on. In this particular example, the entire word 540A-540N is read out because the local memory is so designed for other reasons.

However, for storage memory transactions, all of the bits may not be needed. In this particular example, only the first bit of each word 540A-540N is used, as indicated by the shaded box within each word. The bit address is used as an input to multiplexers (not shown in FIG. 5) to select the first bit. In other implementations, other or additional bits may be used. These first bits are transmitted to the read register 520 and together they form an instruction of length n since there is one bit from each of the n PEs. In another implementation, these same n bits can be obtained by using the entire width, or section thereof, of word 540A, 540B, 540C and so on, until n bits are available. This instruction determines the storage memory transaction. Note that the storage memory transaction was triggered by an instruction only to PE0. Meanwhile, the remaining PEs may receive and execute other instructions, thus increasing the overall efficiency of the simulation processor.

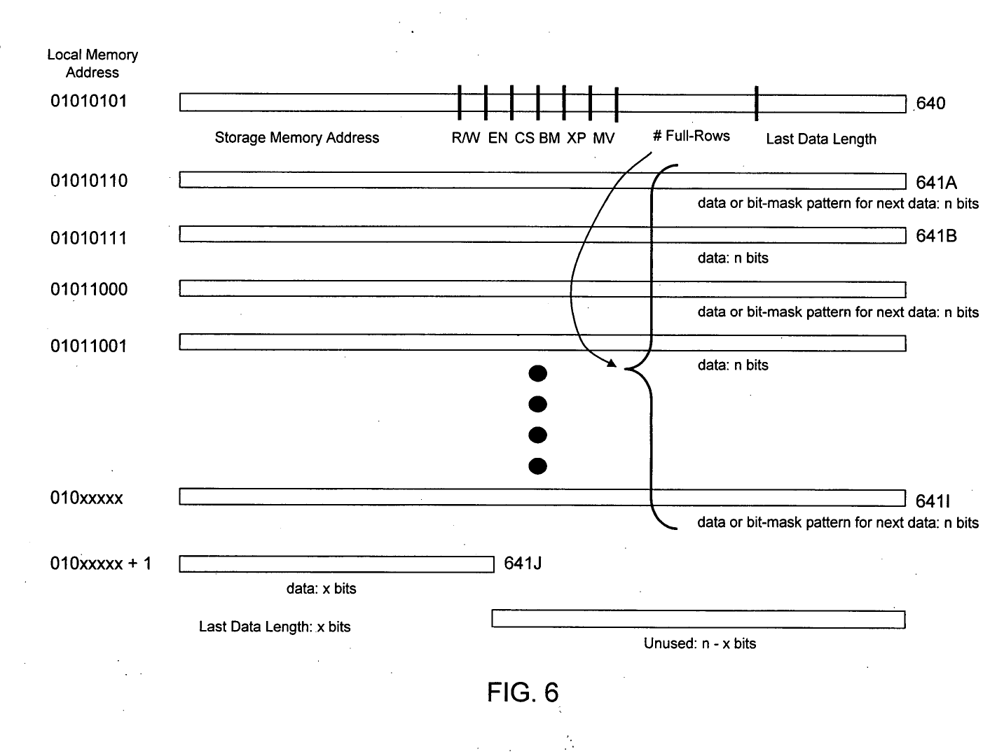

FIG. 6 shows the format of the n-bit storage memory instruction 640, which includes the following fields: Storage Memory Address, R/W (read/write), EN (enable), CS (chip select), BM (bit mask enable), XP (X/Z state present), MV (memory valid), #Full-Rows and Last Data-Length.

The field Storage Memory Address gives the full address of the location in storage memory that will be affected. Note that there are two levels of indirection for the address. The original instruction to the PE contained the address XB1, XB2, Xtra Mem, which points to a location in the local memory 104. That location in local memory 104 contains the field Storage Memory Address, which points to the location in storage memory 122. This indirection allows the instruction sent to the PEs to be much shorter since the full storage memory address typically is much longer than the fields XB1, XB2, Xtra Mem. This is possible in part because not all user memories need be simulated at any one time. For example, the chip typically is simulated one clock domain at a time. As a result, the local memory typically does not need to contain storage memory addresses for user memories that are not in the clock domain currently being simulated.

The field R/W determines the type of memory transaction—either read or write. If R/W is set to W (write), then a write operation is specified, to write data to the storage memory 122 at the location specified by field Storage Memory Address. If R/W is set to R (read), then a read operation is specified, to read data from the storage memory 122 at the location specified by field Storage Memory Address.

The amount of data is determined by the fields BM, #Full-Rows, and Last Data-Length. The field #Full-Rows determines the number of full rows 641A-641I that contain the data to be transferred. The field Last Data-Length determines the length of the last row 641J involved in the data transfer. Each row 641A-641I is considered to be n bits long, except the length of the last row 641J is determined by field Last Data-Length. This allows for data transfers that are not multiples of n. In this way, any size data widths can be supported. When data is modeled as 2-state, the total amount of data that is transported equals the size of the data width that the user has specified. In 4-state, the total amount is twice this, since two bits are used to represent the state of each signal bit, and so on for other numbers of states.

If BM is not set, bit masking is disabled. In this case, each row 641A-641J is interpreted as data. If BM is set, bit masking is enabled. In this case, alternate rows 641A, C, E, etc. are interpreted as bit masks to be applied to the following row 641B, D, F, etc. of data. Bit masks typically have the same width as the data, as bits are often masked on a bit-by-bit basis. Hence, bit masking, when set, doubles the total amount of data. This is less likely to be true for multi-state simulations since, for example, the user may apply bit masking to less than all of the bits that represent the current state. For example, in 4-state, the state of each bit is represented by two bits and bit masking may be applied to only one of the two bits.

EN and CS are fields that are used by the dedicated hardware 130 at run-time to determine whether to actually perform the memory operation. EN and CS typically are not pre-calculated by the compiler. Rather, they are calculated earlier during the simulation. Both EN and CS must be enabled in order for the specified memory operation to occur. If, upon a write, either EN or CS is disabled, then the memory operation (which was previously scheduled by the compiler because it might possibly be required) does not occur. The meaning of the EN bit depends on the R/W bit. If the R/W bit specifies a read operation, then EN operates as an “Output Enable” bit. If the R/W bit specifies a write operation, then EN operates as a “Write Enable” bit.

Fields XP and MV are optional. They are used during 4-state simulation. In 4-state simulation, variables can take on the values X (uninitialized or conflict) or Z (not driven) in addition to 0 (logic low) or 1 (logic high). For example, during the simulation, the EN bit may be X or Z instead of 0 or 1. Similarly, bits in the Storage Memory Address may be X or Z instead of 0 or 1. This is generally true for all variables that are dynamically generated at run-time. However, representing the full four-state value of these variables would require twice as many bits: 2 bits rather than 1 bit for a 4-state EN signal, 2 bits rather than 1 bit for a 4-state CS signal, and also twice as many bits for each of the a0 to an bits in the Storage Memory Address resulting in a doubling of the size of the 4-state Storage Memory Address. The full 4-state representation would significantly increase the length of the storage memory instruction 640.

Instead, in this example, the storage memory instruction 640 is stored in its 4-state representation in local memory 104. However, read register 520 only receives the 2-state representation. This is not necessary, but it is an optimization. Rather than having to transfer the full 4-state representation of these variables, only the 2-state representation is transferred and the field XP or MV is set to invalid if any of the dynamically generated variables is X or Z. Assume that the 4-state encoding is 00 for logic low, 01 for logic high, 10 for X and 11 for Z. The 1sb can be interpreted as the logic level (0 or 1) assuming that the logic level is valid (i.e., not X or Z) and the msb can be interpreted as indicating whether the logic level is valid. A msb=1 indicates an invalid logic level because the state is either X or Z, and msb=0 indicates a valid logic level. The 2-state representation transfers only the 1sb of the 4-state encoding and, rather than transferring every msb for every variable, the two variables XP and MV are used to indicate invalid variables.

If either XP or MV is set to invalid, the memory write operation is not performed because some bit in the Storage Memory Address, EN, CS, etc. is invalid. A memory read operation would return X for the data values, to signify an error. Two separate bits XP and Mv are used in this implementation to facilitate error handling scenarios. An invalid XP indicates to hardware memory interface B 144 that invalid addressing or control is present. An invalid MV indicates to hardware memory interface B 144 that the memory is currently in an invalid state. Both fields can be persistent between operations and can be reset dynamically (e.g., under user logic control) or statically (e.g., scheduled by the compiler). For example, when the memory is in an invalid state, error handling may require that the entire memory appears invalid (X-out the memory). The MV bit can be used for this. The MV bit is set to invalid once the error occurs. This signifies that the memory is not valid and should be treated as such. The MV bit can be reset to valid, for example by resetting the memory directly or when a subsequent valid write request occurs. A memory reset operation can be implemented in hardware, software or in the driver level. The memory is to be filled with X (signifying the error condition) prior to the execution of the write request, having the effect that the user's logic afterwards correctly reads back the data written at the valid address, but reads back an X when reading at any other address location. This is one example of the use of the MV and XP fields. Additional behaviors can be implemented as needed. The MV field can be used as a dynamic controlled signal, enabling the support of certain user logic or compiler driven error scenarios.

With respect to XP, it was noted earlier that the msb of the 4-state encoding indicates whether the bit is valid or invalid. If valid, then the actual bit value is given by the 1sb of the 4-state encoding. Therefore, only the 1sb of the 4-state encoding of the user address bits (i.e., the 2-state representation) is copied to the Storage Memory Address field. Additionally, the values of the msb of the 4-state encodings is checked to detect X or Z. Thus, in 4-state mode, registers 540A-540N store the 4-state representation, i.e. there is an msb and an 1sb. The 1sb bits are copied into read register 520 but the msb bits are not. Rather, XP is calculated in hardware as the logical OR of all the msb bits (excluding the Mv msb). This calculation is performed in the same clock cycle and causes no additional time delay. If the XP value was already set to logic1, or if a logicX or logicZ is detected in any of the msb bits and thus a conflict has occurred, the XP-bit in memory instruction 640 is set to logic1 (i.e., invalid). This logic1 value is then copied into read register 520 as a single bit (2-state), but it is written back to the local memory 104 (through a separate operation, not shown) as a 2-bit (4-state) value. This enables additional dynamic logic error operations to also be triggered (e.g. $display( ) functions).

If the storage memory transaction is a write to storage memory, the data (and bit masks) to be used for the write operation (which are contained in rows 641A-641J in FIG. 6) are contained in consecutive memory locations within the local memory 104. That is, the memory instruction is located at the address XB1, XB2, Xtra Mem. If this data instruction is a write instruction and J rows are specified, that data will be located at the J memory locations after XB1, XB2, Xtra Mem. Note that “after” does not necessarily mean immediately after (i.e., incrementing by a single bit at a time), as the data may be stored in the local memory 104 in an interleaved or other fashion. The data to be written to storage memory 122 is transferred from the local memory 104 to the read register 520, following the same path as shown in FIG. 5, and then to the storage memory 122.

If the storage memory transaction is a read from storage memory, then rows 641A-641J are not required (except for bit masking if that is enabled). Rather, the Storage Memory Address is passed to the storage memory and then data is transferred from the storage memory back to the simulation processor. The amount of data is determined by BM, #Full-Rows and Last Data-Length. The data retrieved from the storage memory is stored in the write register 510 until it can be written to the simulation processor.

FIG. 6 is an example. Other formats will be apparent. For example, the fields XP and MV are not relevant if 2-state operation is being simulated. As another example, the fields EN and CS could be implemented as a single EN bit rather than two separate bits. As a final example, BM can be eliminated if bit masking capability is not supported.

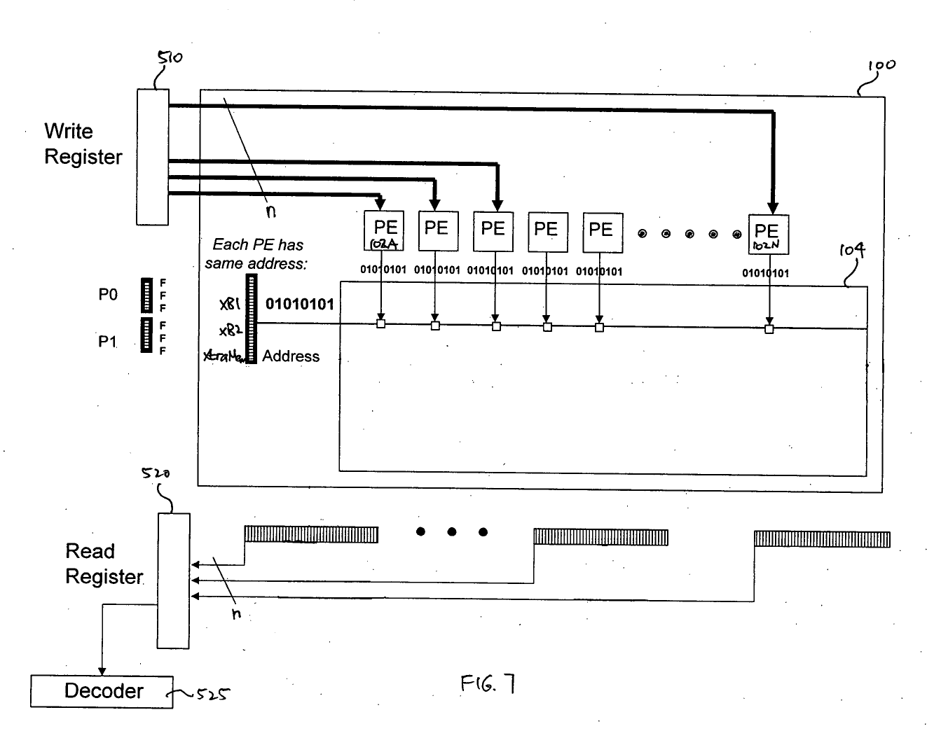

Referring to FIG. 7, when data is ready, the PEs that will be receiving the data receive instructions with EN=11 (i.e., store mode) and P0=P1=FFFF. As with the memory transaction trigger, this particular instruction is an example and other instructions can be used to load data. These PEs also all receive the same XB1, XB2, Xtra Mem fields. Referring to FIG. 4, in the store mode, data is stored to the dedicated local memory 326. Setting P0=P1=FFFF triggers multiplexer 305 to select the input line from the write register 510, thus writing the data retrieved from the storage memory to the local memory 104 at the address determined by XB1, XB2, Xtra Mem (01010101 in FIG. 7). In the example of FIG. 7, all PEs are scheduled to receive data but this is not required. Data can be received by only a subset of the PEs. There typically is a delay between when a read from storage memory is first requested, and when the retrieved data is available at the write register 510. However, this delay is deterministic. The compiler 108 can calculate the delay and then ensure that there is sufficient time delay between these two instructions.

The type of data transferred depends on the context. Typically, data stored in user memory will be transferred back and forth between storage memory and the simulation processor in order to execute the simulation. However, other types of data can also be transferred. For example, through DMA from the main memory 112, the storage memory 122 can be “pre-loaded” with data. This data may be read-only, as in a ROM type of user memory. It can also be data that is not stored in user memories at all. This capability can be useful as a stimulus generation, as stimulus data itself can be large data.

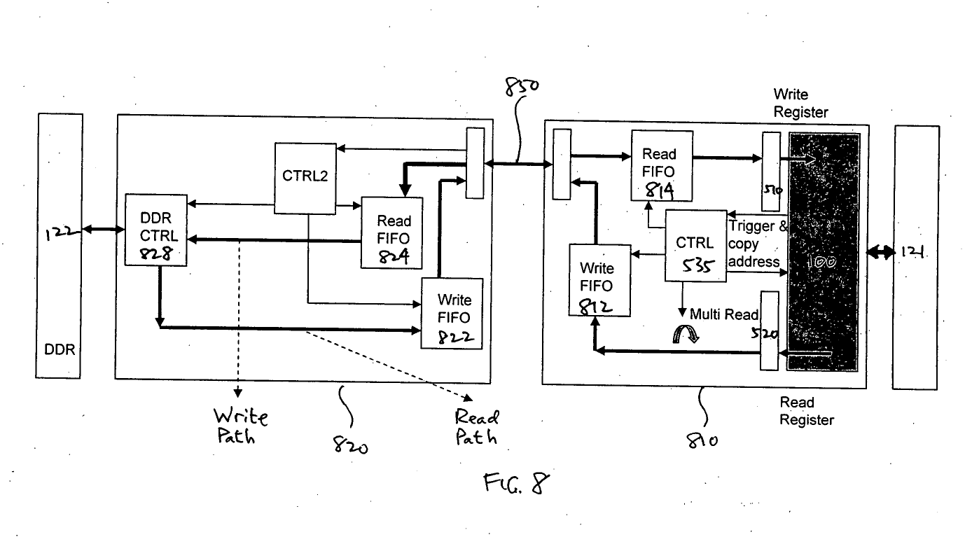

FIG. 8 is a block diagram illustrating an example of the interface between the simulation processor 100 and the storage memory 122. This particular example is divided into two parts 810 and 820, each with its own read FIFOs, write FIFOs and control. The two parts 810 and 820 communicate to each other via an intermediate interface 850. Although this division is not required, one advantage of this approach is that the design is modularized. For example, additional circuitry on the storage memory side 820 can be added to introduce more functionality, for example simulating the characteristics of different types of user memory. Examples of different types of user memory include bit-masking (where only selected bits of a memory word are stored) and content-addressable memories (where a read operation finds data rather than getting a hard-coded address). The same thing can be done on the simulation processor side 810.

The interface in FIG. 8 operates as follows. If the storage memory transaction is a write to storage memory, the storage memory address flows from read register 520 to write FIFO 812 to interface 850 to read FIFO 824 to memory controller 828. The data flows along the same path, finally being written to the storage memory 122. If the storage memory transaction is a read from storage memory, the storage memory address flows along the same path as before. However, data from the storage memory 122 flows through memory controller 828 to write FIFO 822 to interface 850 to read FIFO 814 to write register 510 to simulation processor 100.

Note that reads and writes to storage memory 122 do not interfere with the transfer of instructions from program memory 121 to simulation processor 100, nor do they interfere with the execution of instructions by simulation processor 100. When the simulation processor 100 encounters a read from storage memory instruction, it does not have to wait for completion of that instruction before executing the next instruction. In fact, the simulation processor 100 can continue to execute other instructions while reads and writes to storage memory are pipelined and executing in the remainder of the interface circuitry (assuming no data dependency). This can result in a significant performance advantage.

It should also be noted that the operating frequency for executing instructions on the simulation processor 100 and the data transfer frequency (bandwidth) for access to the storage memory 122 generally differ. In practice, the operating frequency for instruction execution is typically limited by the bandwidth to the program memory 121 since instructions are fetched from the program memory 121. The data transfer frequency to/from the storage memory 121 typically is limited by either the bandwidth to the storage memory 121 (e.g., between controller 828 and storage memory 121), the access to the simulation processor 100 (via read register 510 and write register 520) or by the bandwidth across interface 850.

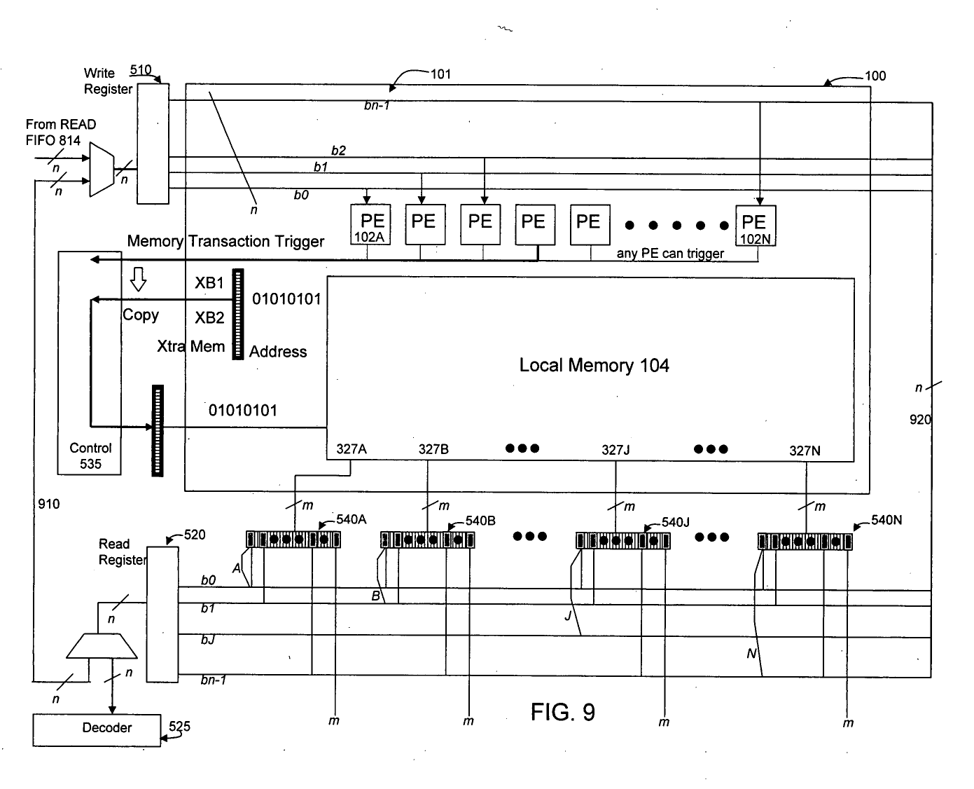

FIGS. 9-14 show one variation of the architecture shown in FIGS. 5-8. FIG. 9 is a circuit diagram that shows an alternate memory architecture to that shown in FIG. 5. The architecture in FIG. 9 is similar to that in FIG. 5. Both architectures include a write register 510, read register 520 and simulation processor 100. Furthermore, the simulation processor 100 includes n PEs 102A-102N and a local memory 104.

However, the architecture in FIG. 9 is different in the following ways. First, the local memory 104 is a dual-port memory. The data words 540A-540N can both be read out from the local memory 104 via ports 327A-327N and written back to the local memory 104 via ports 327A-327N. This can be referred to as direct-write. In actual implementation, each port 327 may be realized as two separate ports but they are shown as a single bidirectional port in FIG. 9 for convenience. Also, recall that the local memory 104 is shown as a single structure but is implemented in this example as n separate memories 326 dedicated to specific processor elements (as in FIG. 4).

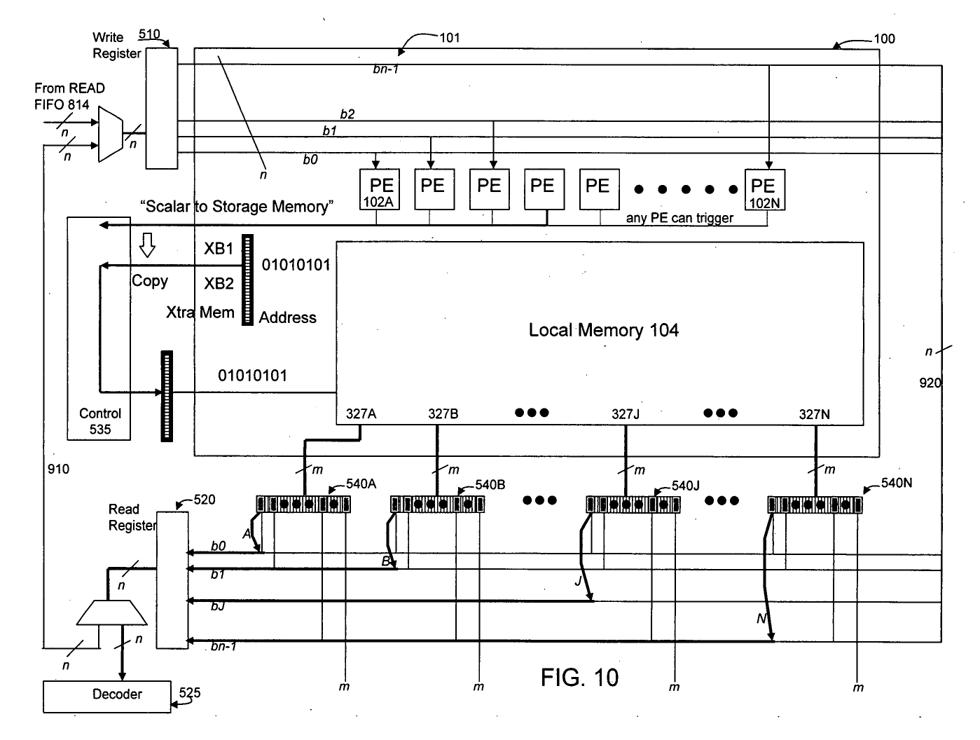

In this example, each data word is m bits long and the words handled by the read register 520 and write register 510 are n bits long. Furthermore, it is assumed that m>n although any relation between m and n can be supported. The first n bits in each data word 540A-540N map to the n bits for the read register 520, one for one. The remaining bits in the data word 540 can be mapped to the n read register bits in any manner, depending on the architecture. In addition, the first bit in each data word 540A-540N can also be mapped to a corresponding bit for the read register 520. That is, the first bit in data word 540A can be mapped to bit b0, the first bit in data word 540B to bit b1, the first bit in data word 540C to bit b2, and so on. This alternate mapping is represented in FIG. 9 by two lines emanating from each first bit. For data word 540B, a first straight line emanates from the first bit and connects to bit b0 and a second line with three segments emanates from the first bit and connects to bit b1. Physically, this functionality can be implemented by multiplexers and demultiplexers. As will be shown in FIGS. 10-14, this architecture allows flexibility to handle data on a bit-level or on a word-level.

Another difference is the architecture in FIG. 9 includes a loopback path 910 that bypasses the storage memory 122. By activating the loopback path 910, data can be transferred from the read register 520 directly to the write register 510 without having to pass through the storage memory 122. In an analogous fashion, a loop forward path 920 allows data to be transferred from the interconnect system 101 directly to the memory ports 327 without having to pass through the PE fabric 102. In one variation, when data is looping back from the local memory 104 to inputs of the simulation processor 100, the loopback path 910 can bypass the read register 520 or the write register 510, thus reducing the latency of the loopback data transfer.

FIGS. 10-14 illustrate different read and write operations that can be implemented by the architecture of FIG. 9. FIG. 10 shows the same operation as in FIG. 5. One of the PEs 102 receives an instruction that triggers a “scalar to storage memory” transaction. The label “scalar to storage memory” is used because the data for local memory 104 is treated in a scalar fashion (one bit for each port 327A-327N) and the data is transferred between the local memory 104 and the storage memory 122 (as opposed to the write register 510, for example). As in FIG. 5, the fields XB1, XB2 and Xtra Mem in the instruction are interpreted as an address into the local memory 104. The control circuitry 535 applies the word address portion of this memory address to the output ports 327 of the local memory 104 corresponding to all n processor elements and reads out the n data words 540 stored at this local memory address. Hardware is triggered to connect the first bit of each data word 540 to the corresponding read register bit bn, as shown by the heavy lines in FIG. 10. The decoder 525 interprets the memory instruction as described above with respect to FIG. 6.

FIG. 1 shows a “vector to storage memory” transaction. The operation is similar to FIG. 10, except the instructions specify that the data comes from many bits within a single data word 540J, rather than one bit from each data word 540A-540N. Hence, this is referred to a “vector” memory operation.

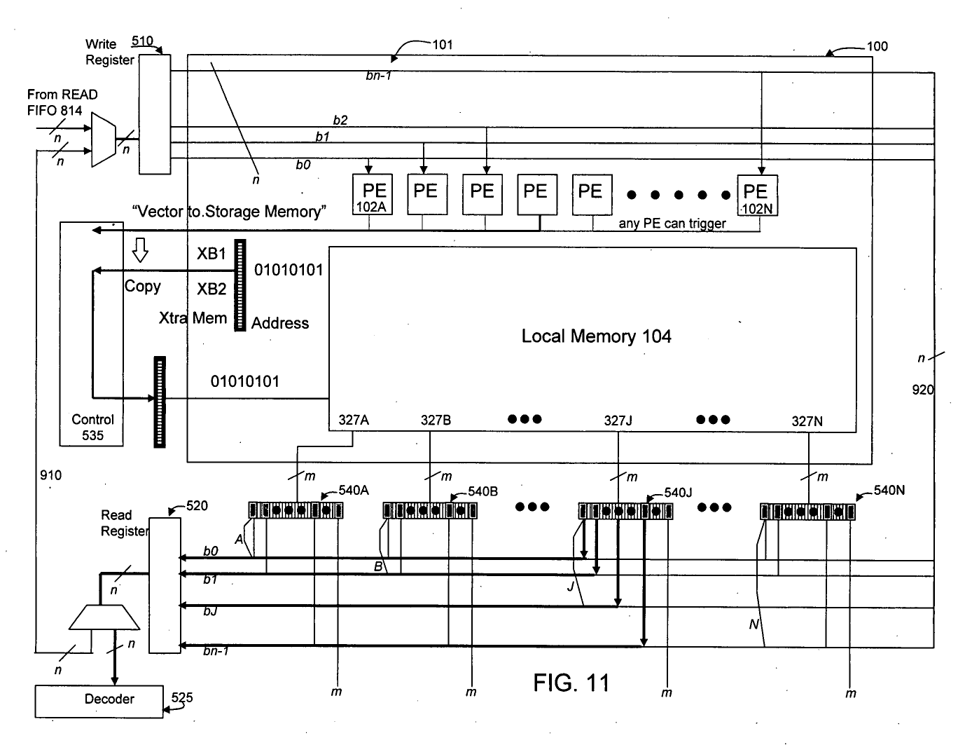

Rather than transferring data between the local memory 104 and the storage memory 122, other operations can transfer data to the write register 510. A “scalar to write register” transaction would be similar to FIG. 10, except that multiplexers would route the data from read register 520 to write register 510, rather than to the decoder 525. Similarly, a “vector to write register” transaction would be similar to FIG. 11, except data is routed to the write register 510 rather than to the decoder 525. In these “write register” transactions, the data likely will not be a storage memory instruction (as shown in FIG. 6), since the storage memory is not involved. Rather, these operations can be used simply to transfer data from the local memory 104 to the PEs 102 for use.

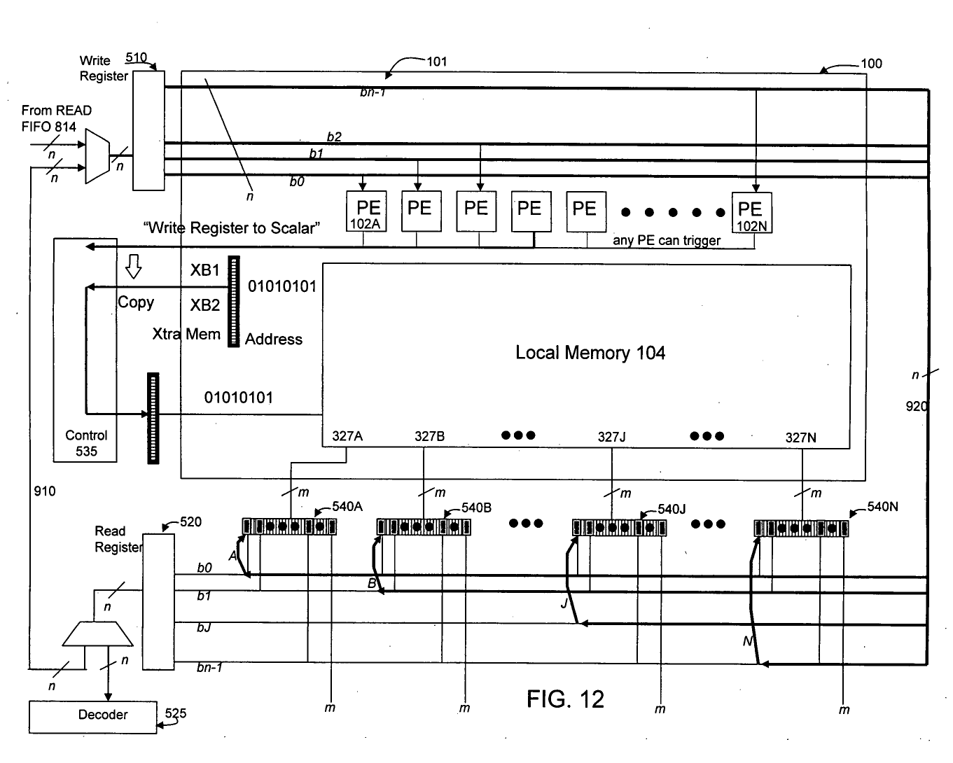

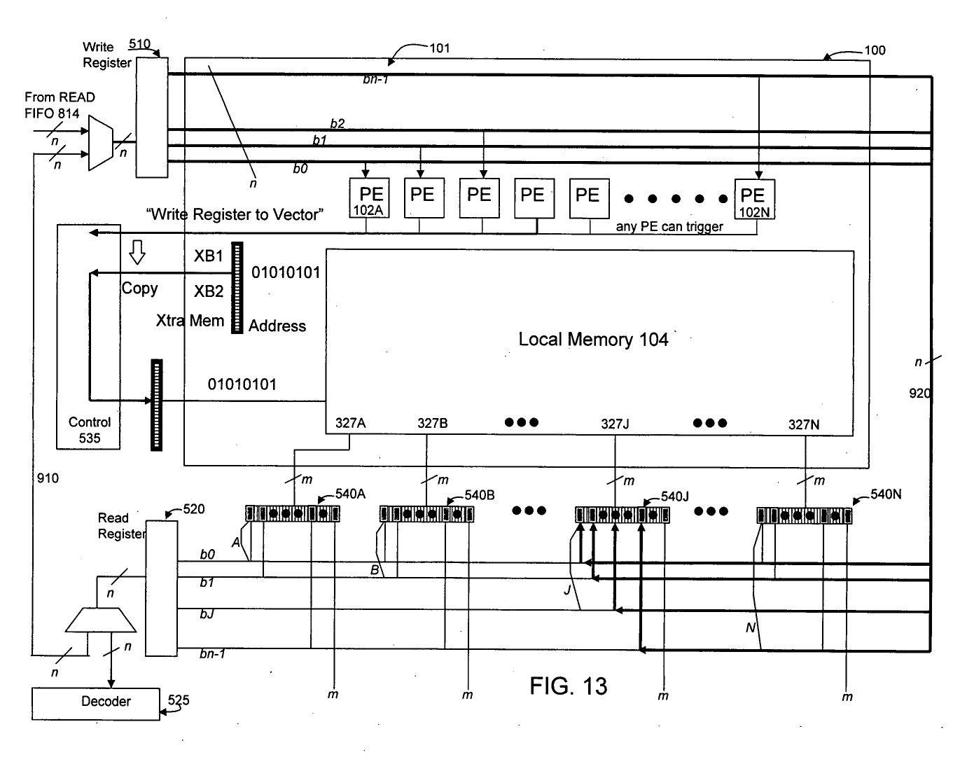

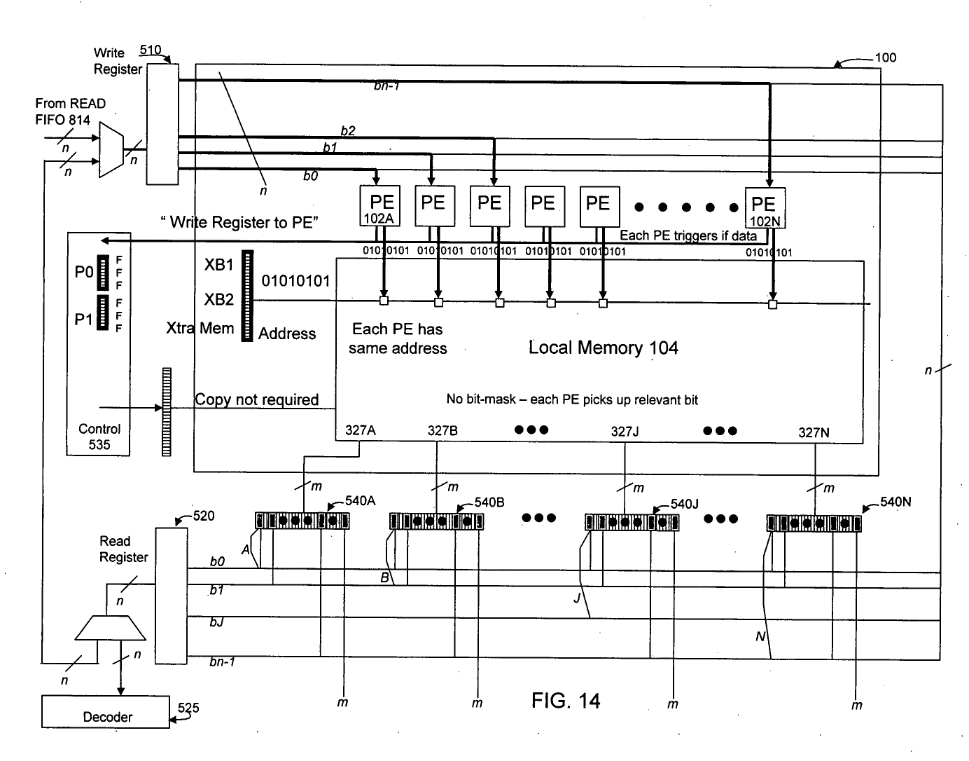

FIGS. 12 and 13 show two examples of writing data to the local memory 104. In both of these examples, data is written from the write register 510 to the local memory 104. In FIG. 12, the operation is a “write register to scalar” transaction because the data from the write register 510 is written one bit to each data word 540A-540N, and stored as one bit in each of the dedicated local memories 326A-326N (via ports 327A-327N). In FIG. 13, the operation is a “write register to vector” transaction because the data from the write register 510 is written all to a single data word 540J and corresponding dedicated local memory 326J (via port 327J). FIG. 14 shows a “write register to PE” transaction, which is the same as in FIG. 7.

These operations can be combined to implement fast vector to scalar, and scalar to vector conversions. If data is stored in a “vector” format in dedicated local memory 326J, it can be converted to a scalar format by combining the “vector to write register” transaction with the “write register to scalar” transaction. Similarly, a scalar to vector conversion can be implemented by combining a “scalar to write register” transaction with a “write register to vector” transaction. This is advantageous when switching between vector and scalar mode operations.

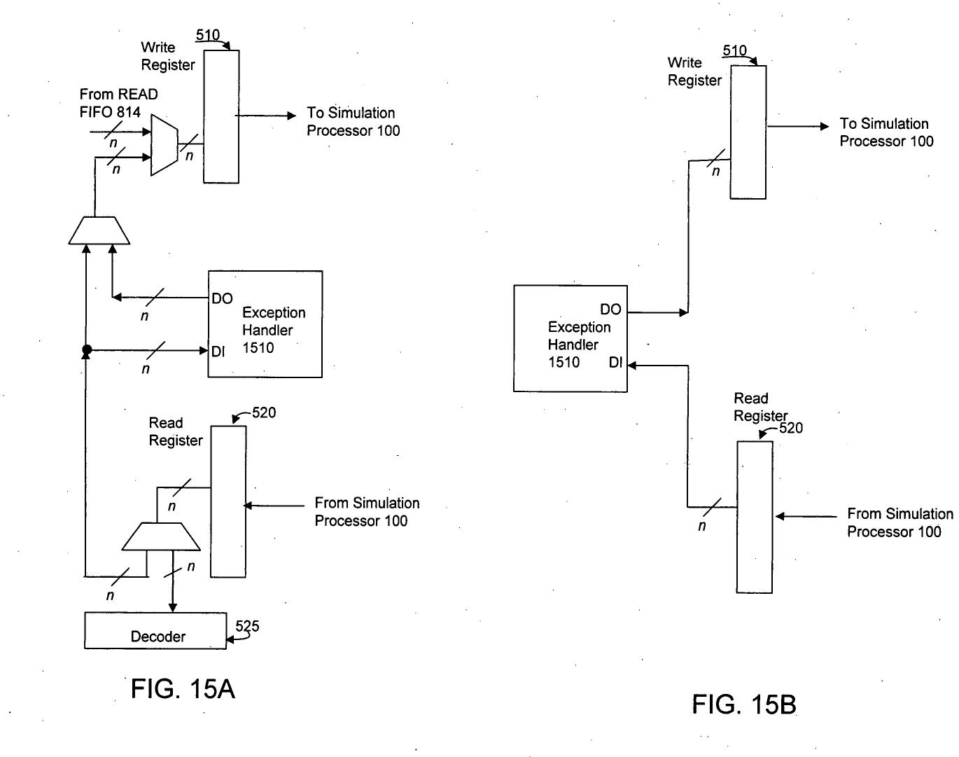

The example of FIGS. 9-14 introduce more complex data handling compared to FIG. 5. FIGS. 15A and 15B are circuit diagrams of architectures that use an exception handler to support more complex functions. In FIG. 15A, an exception handler 1510 is inserted as an alternate path in the loopback path 910. For direct loopback, data transfers from the read register 520 directly to the write register 510. On the alternate path, data transfers from the read register 520 to the exception handler 1510 to the write register 510. The exception handler can handle many different functions and may have other ports, for example connecting to other circuitry, processors, or data sources/sinks. FIG. 15B shows an alternate architecture, in which interactions with the read register 520 and write register 510 are handled by the exception handler 1510. The direct loopback path from read register 520 to write register 510, the interactions with storage memory 122, etc. are all handled through the exception handler 1510.

The exception handler 1510 typically is a multi-bit in, multi-bit out device. In one design, the exception handler 1510 is implemented using a PowerPC core (or other microprocessor or microcontroller core). In other designs, the exception handler 1510 can be implemented as a (general purpose) arithmetic unit. Depending on the design, the exception handler 1510 can be implemented in different locations. For example, if the exception handler 1510 is implemented as part of the VLIW simulation processor 100, then its operation can be controlled by the VLIW instructions 118. Referring to FIG. 4, in one implementation, some of the processor units 103 are modified so that the PE 302 receives multi-bit inputs from multiplexers 305, 306, rather than single bit inputs. The PE 302 can then perform arithmetic functions on the received vector data. The data can be converted between vector and scalar forms using, for example, the techniques illustrated in FIGS. 10-13.

In an alternate approach, the exception handler 1510 can be implemented by circuitry (and/or software) external to the VLIW simulation processor 100. For example, referring to FIG. 8, the exception handler 1510 can be implemented on circuitry located on 810 but external to the simulation processor 100. One advantage of this approach is that the exception handler 1510 is not driven by the VLIW instruction 118 and therefore does not have to operate in lock step with the rest of the simulation processor 100. In addition, the exception handler 1510 can more easily be designed to handle large data operations since it is not directly constrained by the architecture of the simulation processor.

In another variation, the memory transactions described above are implemented on a word level rather than on a bit level. For example, in FIG. 5, one bit from each word 540A-540N was involved in the memory transaction. In this variation, the entire word (or, more generally, any subset of bits) is involved. In this variation, the PEs preferably are configured to operate on the same width data. For example, the PEs may be configured to operate on 4-state variables, with each 4-state operand represented by two bits. In that case, the memory transactions may retrieve two bits from words 540A-540N. Further details on 4-state and other multi-state operation are described in U.S. Provisional Patent Application Ser. No. 60/732,078, “VLIW Acceleration System Using Multi-State Logic,” filed Oct. 31, 2005, which is incorporated herein by reference.

Although the present invention has been described above with respect to several embodiments, various modifications can be made within the scope of the present invention. For example, although the present invention is described in the context of PEs that are the same, alternate embodiments can use different types of PEs and different numbers of PEs. The PEs also are not required to have the same connectivity. PEs may also share resources. For example, more than one PE may write to the same shift register and/or local memory. The reverse is also true, a single PE may write to more than one shift register and/or local memory.

As another example, the instruction 382 shown in FIG. 4 shows distinct fields for P0, P1, etc. and the overall operation of the instruction set was described in the context of four primary operational modes. This was done for clarity of illustration. In various embodiments, more sophisticated coding of the instruction set may result in instructions with overlapping fields or fields that do not have a clean one-to-one correspondence with physical structures or operational modes. One example is given in the use of fields XB1, XB2 and Xtra Mem. These fields take different meanings depending on the rest of the instruction. Local memory addresses may be determined by fields other than XB1, XB2 and Xtra Mem. In addition, symmetries or duality in operation may also be used to reduce the instruction length.

In another aspect, the simulation processor 100 of the present invention can be realized in ASIC (Application-Specific Integrated Circuit) or FPGA (Field-Programmable Gate Array) or other types of integrated circuits. It also need not be implemented on a separate circuit board or plugged into the host computer 110. There may be no separate host computer 110. For example, referring to FIG. 1, CPU 114 and simulation processor 100 may be more closely integrated, or perhaps even implemented as a single integrated computing device.

As another example, the storage memory 122 can be used to store information other than just intermediate results. For example, the storage memory 122 can be used for stimulus generation. The stimulus data for the design being simulated can be stored in the storage memory 122 using DMA access from the host computer 110. Upon run-time execution, this data is retrieved from the storage memory 122 through the memory access methods described above. In this example, the stimulus is modeled as a ROM (read only memory). The inverse can also be utilized. For example, certain data (e.g., a history of the functional simulation) can be captured and stored in storage memory 122 for retrieval using DMA from the host computer 110. In this case, the memory is modeled as a WOM (write only memory). In an alternate approach, the host computer 110 can send stimulus data to storage memory 122, modeled as a ROM with respect to the simulation processor 100, and obtain response data from storage memory 122, modeled as a WOM with respect to simulation processor 100.

In one implementation designed for logic simulation, the program memory 121 and storage memory 122 have different bandwidths and access methods. Referring to FIG. 8, the two parts 810 and 820 can be modeled as a main processor 810 and co-processor 820 connected by interface 850. Program memory 121 connects directly to the main processor 810 and has been realized with a bandwidth of over 200 billion bits per second. Storage memory 122 connects to the co-processor 820 and has been realized with a bandwidth of over 20 billion bits per second. As storage memory 122 is not directly connected to the main processor 810, latency (including interface 850) is a factor. In one specific design, program memory 121 is physically realized as a reg [2,560] mem [8M], and storage memory 122 is physically realized as a reg [256] mem [125M] but is further divided by hardware and software logic into a reg [64] mem [500M]. Relatively speaking, program memory 121 is wide (2,560 bits per word) and shallow (8 million words), whereas storage memory 122 is narrow (64 bits per word) and deep (500 million words). This should be taken into account when deciding on which DMA transfer (to either of the program memory 121 and the storage memory 122) to use for which amount and frequency of data transfer. For this reason, the VLIW processor can be operated in co-simulation mode or stimulus mode.

In co-simulation mode, a software simulator is being executed on the host CPU 114, using the main memory 112 for internal variables. When the hardware mapped portion needs to be simulated, the software simulator invokes a request for response data from the hardware mapped portion, based on the current input data (at that time-step). In this mode, a software driver, which is a software program that communicates directly to the software simulator and has access to the DMA interfaces to the hardware simulator 130, transfers the current input data (single stimulus vector) from the software simulator to the hardware simulator 130 by using DMA into program memory 121. Upon completion of the execution for this input data set, the requested response data (single response vector) is also stored in program memory 121. The software driver then uses DMA to retrieve the response data from the program memory 121 and communicate it back to the software simulator.

In stimulus mode, there is no need for a software simulator being executed on the host CPU 114. Only the software driver is used. In this mode, the hardware accelerator 130 can be viewed as a data-driven machine that prepares stimulus data (DMA from the host computer 110 to the hardware simulator 130), executes (issues start command), and obtains stimulus response (DMA from the hardware simulator 130 to the host computer 110).

The two usage models have different characteristics. In co-simulation with a software simulator, there can be significant overhead observed in the run-time and communication time of the software simulator itself. The software simulator is generating, or reading, the vast amount of stimulus data based on execution in CPU 114. At any one time, the data set to be transferred to the hardware simulator 130 reflects the I/O to the logic portion mapped onto the hardware simulator 130. There typically will be many DMA requests in and out of the hardware simulator 130, but the data sets will typically be small. Therefore, use of program memory 121 is preferred over storage memory 122 for this data communication because the program memory 121 is wide and shallow.

In stimulus mode, the interactions to the software simulator may be non-existent (e.g. software driver only), or may be at a higher level (e.g. protocol boundaries rather than vector/clock boundaries). In this mode, the amount of data being transferred to/from the host computer 110 typically will be much larger. Therefore, storage memory 122 is typically a preferred location for the larger amount of data (e.g. stimulus and response vectors) because it is narrow and deep.

By selecting which data is stored in program memory 121 and which data is stored in storage memory 122, a balance can be achieved between response time and data size. Similarly, data produced during the execution of program memory 121 can also be stored in either of the program memory 121 and the storage memory 122 and be made available for DMA access upon completion.

Because of the sheer size of both the program memory 121 and the storage memory 122, in many cases, it is feasible to DMA the entire program content, needed for execution, into program memory 121 and to DMA the entire data set, both stimulus and response (obtained by executing the program in the hardware simulator) into storage memory 122 and/or program memory 121.

The stimulus mode also shows a mode which can be extended to non-simulation applications. For example, if the PEs are capable of integer or floating point arithmetic (as described in U.S. Provisional Patent Application Ser. No. 60/732,078, “VLIW Acceleration System Using Multi-State Logic,” filed Oct. 31, 2005, hereby incorporated by reference in its entirety), the stimulus mode enables a general purpose data driven computer to be created. For example, the stimulus data might be raw data obtained by computer tomography. The hardware accelerator 130 is an integer or floating point accelerator which produces the output data, in this case the 3D images that need to be computed. As the amounts of data are vast, in this application, the software driver would keep loading the storage memory 122 with additional stimulus data while concurrently retrieving the output data, in an ongoing fashion. This approach is suited for a large variety of parallelizable, compute intensive, programs.

Although the present invention is described in the context of logic simulation for semiconductor chips, the VLIW processor architecture presented here can also be used for other applications. For example, the processor architecture can be extended from single bit, 2-state, logic simulation to 2 bit, 4-state logic simulation, to fixed width computing (e.g., DSP programming), and to floating point computing (e.g. IEEE-754). Applications that have inherent parallelism are good candidates for this processor architecture. In the area of scientific computing, examples include climate modeling, geophysics and seismic analysis for oil and gas exploration, nuclear simulations, computational fluid dynamics, particle physics, financial modeling and materials science, finite element modeling, and computer tomography such as MRI. In the life sciences and biotechnology, computational chemistry and biology, protein folding and simulation of biological systems, DNA sequencing, pharmacogenomics, and in silico drug discovery are some examples. Nanotechnology applications may include molecular modeling and simulation, density functional theory, atom-atom dynamics, and quantum analysis. Examples of digital content creation include animation, compositing and rendering, video processing and editing, and image processing. Accordingly, the disclosure of the present invention is intended to be illustrative, but not limiting, of the scope of the invention, which is set forth in the following claims.

What is claimed is:

1. A method for functional simulation of a user chip design, the user chip design including user logic and user memory, the method comprising:
compiling a description of the user chip design into a program, the program containing instructions that simulate the user logic and also containing instructions that simulate access to the user memory; and
executing the instructions on a simulation processor.

2. The method of claim 1 wherein the step of compiling a description of the user chip design into a program comprises:
mapping user memory addresses into storage memory addresses for a storage memory coupled to the simulation processor; and
compiling accesses to user memory at a specific user memory address into instructions that access storage memory at the corresponding storage memory address.

3. The method of claim 2 wherein, for at least one instance of user memory, the corresponding storage memory addresses include selected bits from the user memory addresses and no translation of the user memory address to the corresponding storage memory address is performed at run-time of the instruction.

4. The method of claim 2 wherein, for at least one instance of user memory, the corresponding storage memory addresses includes a fixed offset concatenated with selected bits from the user memory addresses.

5. The method of claim 2 wherein, for at least one instance of user memory, the corresponding storage memory addresses include a fixed number of least significant bits from the user memory addresses.

6. The method of claim 2 wherein, for at least one instance of user memory, the corresponding storage memory addresses include ceil(log2(N)) least significant bits from the user memory addresses where N is the number of user memory addresses in the instance of user memory.

7. The method of claim 2 wherein, for at least one instance of user memory, the corresponding storage memory addresses includes all bits from the user memory addresses.

8. The method of claim 2 wherein the step of compiling a description of the user chip design into a program comprises:
mapping user memory addresses into storage memory addresses that are based on a simple logic function applied to the user memory address.

9. The method of claim 2 wherein the step of executing the instructions on a simulation processor comprises:
accessing the storage memory without blocking a transfer of instructions between the simulation processor and a program memory that is separate from the storage memory.

10. The method of claim 2 wherein the step of executing the instructions on a simulation processor comprises:
accessing the storage memory without blocking execution of other instructions by the simulation processor.

11. The method of claim 2 wherein the step of executing the instructions on a simulation processor comprises:
executing an instruction that triggers a storage memory transaction, wherein the instruction points to a location in a local memory of the simulation processor that includes a storage memory instruction further specifying the storage memory transaction.

12. The method of claim 11 wherein the storage memory instruction includes a storage memory address corresponding to the user memory address being simulated by the instruction.

13. The method of claim 12 wherein the storage memory address includes a fixed offset for the corresponding user memory concatenated with selected bits from the corresponding user memory address.

14. The method of claim 11 wherein the storage memory instruction includes a field to indicate whether the storage memory transaction is a read operation or a write operation.

15. The method of claim 11 wherein the storage memory instruction includes a field to indicate whether or not the storage memory transaction is enabled.

16. The method of claim 11 wherein the storage memory instruction includes a field to indicate whether or not bit masking is enabled.

17. The method of claim 11 wherein the storage memory instruction includes a field to indicate whether any dynamically generated fields in the storage memory instruction are invalid.

18. The method of claim 11 wherein simulation of the user logic and of the user memory is a 4-state simulation and the storage memory instruction includes a field to indicate whether any dynamically generated fields in the storage memory instruction contain X or Z.

19. The method of claim 11 wherein simulation of the user logic and of the user memory is a 4-state simulation and the storage memory instruction includes a memory valid field.

20. The method of claim 1 wherein the description of the user memory in the user chip design includes a behavioral model of the user memory.

21. The method of claim 20 wherein the description of the user logic in the user chip design includes a gate-level netlist of the user logic.

22. The method of claim 1 wherein the program further contains instructions to read data from a storage memory coupled to the simulation processor on a read-only basis.

23. The method of claim 22 wherein the data read from the storage memory is stimulus data for the functional simulation of the user chip design.

24. The method of claim 23 wherein the host computer writes the stimulus data to the storage memory without pausing operation of the simulation processor.

25. The method of claim 1 wherein the program further contains instructions to write data to a storage memory coupled to the simulation processor on a write-only basis.

26. The method of claim 25 wherein the data written to the storage memory includes history data for the functional simulation of the user chip design.

27. The method of claim 26 wherein the host computer reads the history data from the storage memory without pausing operation of the simulation processor.

28. A hardware-accelerated simulation system for simulating a function of a user chip design, the user chip design including user logic and user memory and the simulated functions including a write-to-user-memory and a read-from-user-memory, the hardware-accelerated simulation system comprising:
a simulation processor comprising n processor units, the processor units including processor elements configurable to simulate the user logic;
a storage memory accessible by the simulation processor for simulating the user memory; and
a program memory separately accessible by the simulation processor for storing a program containing instructions that simulate both the user logic and accesses to the user memory, the instructions executable by the simulation processor.

29. The hardware-accelerated simulation system of claim 28 wherein:
write-to-user-memory and read-from-user-memory are simulated by instructions that write to storage memory and read from storage memory, respectively; and
reading from and writing to the storage memory does not block a transfer of instructions between the program memory and the simulation processor.

30. The hardware-accelerated simulation system of claim 28 wherein:
write-to-user-memory and read-from-user-memory are simulated by instructions that write to storage memory and read from storage memory, respectively; and
reading from and writing to the storage memory does not-block execution of instructions that simulate user logic.

31. The hardware-accelerated simulation system of claim 28 wherein:
the simulation processor further comprises a local memory; and
the instructions that simulate write-to-user-memory or read-from-user-memory at a specific user memory address include a local memory address; and the local memory at the local memory address contains a storage memory instruction that accesses the storage memory at a storage memory address corresponding to the user memory address.

32. The hardware-accelerated simulation system of claim 31 wherein the storage memory address includes selected bits from the user memory address.

33. The hardware-accelerated simulation system of claim 32 wherein the storage memory address includes a pre-determined fixed offset for the user memory concatenated with selected bits from the corresponding user memory address.

34. The hardware-accelerated simulation system of claim 31 wherein the instruction that includes the local memory address is executed by only one processor unit but the storage memory instruction contained in the local memory affects the local memory of more than one processor unit.

35. The hardware-accelerated simulation system of claim 28 wherein instructions that simulate write-to-user-memory include writing data to the storage memory from the local memory.

36. The hardware-accelerated simulation system of claim 35 wherein the processor units include dedicated local memories and instructions that simulate write-to-user-memory include writing to the storage memory from two or more dedicated local memories.

37. The hardware-accelerated simulation system of claim 35 wherein the processor units include dedicated local memories and instructions that simulate write-to-user-memory include writing to the storage memory exactly one bit from every dedicated local memory.

38. The hardware-accelerated simulation system of claim 35 wherein the processor units include dedicated local memories and instructions that simulate write-to-user-memory include writing to the storage memory one word from exactly one dedicated local memory.

39. The hardware-accelerated simulation system of claim 35 wherein the processor units include dedicated local memories and instructions that simulate write-to-user-memory include writing to the storage memory at least one bit from at least one dedicated local memory.

40. The hardware-accelerated simulation system of claim 35 wherein at least one instruction that simulates write-to-user-memory includes only a single data transfer from local memory to the storage memory.

41. The hardware-accelerated simulation system of claim 35 wherein at least one instruction that simulates write-to-user-memory includes two or more data transfers from local memory to the storage memory.

42. The hardware-accelerated simulation system of claim 28 wherein the instructions that simulate read-from-user-memory include reading data from the storage memory to the local memory.

43. The hardware-accelerated simulation system of claim 42 wherein the instructions that simulate read-from-user-memory include reading data from the storage memory to two or more dedicated local memories.

44. The hardware-accelerated simulation system of claim 28 further comprising:
a read register coupled to local memory that is part of the simulation processor, wherein data can be transferred from the local memory to the read register for further transfer to the storage memory; and
a write register coupled to the processor units and to the local memory, wherein data can be transferred from the storage memory to the write register for further transfer to the processor units or to the local memory.

45. The hardware-accelerated simulation system of claim 44 wherein the local memory comprises dedicated local memories for each process unit, data can be transferred from the dedicated local memories to the read register for further transfer to the storage memory, and data can be transferred from the storage memory to the write register for further transfer to the processor units or to the dedicated local memories.

46. The hardware-accelerated simulation system of claim 44 further comprising:
a loop forward path from the write register to the read register, bypassing the processor units.

47. The hardware-accelerated simulation system of claim 28 further comprising:
a read register coupled to local memory that is part of the simulation processor, wherein data can be transferred from the local memory to the read register for further transfer to the storage memory; and
a write register coupled to the processor units, wherein data can be transferred from the storage memory to the write register for further transfer to the processor units.

48. The hardware-accelerated simulation system of claim 47 further comprising:
a multiplexer for bypassing the read register.

49. The hardware-accelerated simulation system of claim 47 further comprising:
a multiplexer for bypassing the write register.

50. The hardware-accelerated simulation system of claim 47 further comprising:
a loopback path from the read register to the write register, bypassing the storage memory.

51. The hardware-accelerated simulation system of claim 47 further comprising:
an exception handler coupled between the read register and the write register.

52. The hardware-accelerated simulation system of claim 51 wherein the exception handler comprises a processor core.

53. The hardware-accelerated simulation system of claim 51 wherein the exception handler comprises an arithmetic unit.

54. The hardware-accelerated simulation system of claim 51 wherein the simulation processor includes the exception handler.

55. The hardware-accelerated simulation system of claim 51 wherein the exception handler is implemented as circuitry external to the simulation processor.

56. The hardware-accelerated simulation system of claim 28 further comprising an interface between the simulation processor and the storage memory comprising:
a simulation processor part coupled to the simulation processor for controlling reads and writes to the simulation processor;
a storage memory part coupled to the storage memory for controlling reads and writes to the storage memory; and
an intermediate interface coupling the simulation processor part with the storage memory part.

57. The hardware-accelerated simulation system of claim 28 wherein the simulation processor is implemented on a board that is pluggable into a host computer.

58. The hardware-accelerated simulation system of claim 57 wherein the simulation processor has direct access to a main memory of the host computer.
